(19) United States
(12) Patent Application Publication
(10) Pub. No.: US 2025/0111672 A1
(43) Pub. Date: Apr. 3, 2025

(54) Analysis of Non-nutritive Sucking in Infants Using Computer Vision and Action Segmentation

(71) Applicant: Northeastern University, Boston, MA (US)

(72) Inventors: Sarah OSTADABBAS, Watertown, MA (US); Emily ZIMMERMAN, Boston, MA (US); Michael WAN, Brunswick, ME (US); Elaheh HATAMIMAJOUMERD, Boston, MA (US); Shaotong ZHU, Boston, MA (US)

(21) Appl. No.: 18/903,566

(22) Filed: Oct. 1, 2024

Related U.S. Application Data
(60) Provisional application No. 63/542,082, filed on Oct. 2, 2023.

(51) Int. Cl. G06V 20/40; G06T 7/246; G06V 10/774; G06V 40/16; G06V 40/20

(52) U.S. Cl. CPC G06V 20/41; G06T 7/246; G06V 10/774; G06V 20/49; G06V 40/161; G06V 40/20

(57) ABSTRACT

Provided herein are methods and systems for detecting non-nutritive sucking (NNS) by an infant in a video recording and determining the start and end times of the NNS. The NNS detection method includes creating video segments from the video recording. For each video segment, action recognition is performed that includes determining a face bounding box for each frame of the video segment. The frames are cropped based on the bounding box. For each cropped frame, an optical flow frame is generated of the optical flow direction vectors for pixels of the cropped frame. Using a convolution network and the optical flow frames, a segment feature vector is determined from the pre-classification feature layer of the convolution network. The segment feature vector corresponding to each video segment is used as input to a dilated convolution network to predict an NNS action and determine the start and end time of the NNS.

### CROSS REFERENCE TO RELATED APPLICATIONS

This application claims the priority of U.S. Provisional Application No. 63/542,082 filed Oct. 2, 2023 and entitled “Analysis of Non-Nutritive Sucking in Infants Using Computer Vision and Action Segmentation”, the whole of which is hereby incorporated by reference.

### STATEMENT REGARDING FEDERALLY SPONSORED RESEARCH OR DEVELOPMENT

This invention was made with government support under Grant No. 2143882 awarded by the National Science Foundation. The government has certain rights in the invention.

### BACKGROUND

Infant feeding requires a delicate harmony between sucking, swallowing, and breathing movements, often presenting a challenge for newborn and especially preterm infants: around 2.8 million infants in all face feeding challenges per year in the U.S. Nurse clinicians often gauge feeding readiness with subjective finger-in-mouth assessments of non-nutritive sucking (NNS)—sucking without nutrient delivery—but this can cause discomfort or lead to serious complications if the assessment is mistaken [1]. An automated, objective, video-based tool for tracking infant NNS would help address these concerns, and pave the way for a fully automated contactless feeding assessment system in the future. Aside from aiding clinical decision-making in real-time, such a tool could also benefit research in infant neurodevelopmental diagnostics. Given the limited range of motor function and means of expression in infancy, characteristics of NNS constitute critical signals of neural and motor development in early life [24, 33], and NNS has even been proposed as a potential mechanism for reducing the risk of sudden infant death syndrome (SIDS) [28, 36], the leading cause of death of US infants aged between 1 and 12 months [3]. Understanding the relation between NNS patterns and characteristics of breathing, feeding, and arousal during sleep could enhance scientific understanding of infant neurodevelopment and protective factors for SIDS. Nonetheless, few such studies have been conducted, partly due to the difficulty of measuring the NNS signal.

Non-nutritive sucking typically manifests in bursts comprising approximately 6 to 12 sucks, occurring at a rate of 2 Hz per suck. These bursts sporadically appear a few times per minute during periods of heightened non-nutritive sucking activity [38]. Nevertheless, active nonnutritive sucking phases can be infrequent, often constituting only a few minutes per hour. This intermittent nature of non-nutritive sucking imposes a substantial workload on clinicians and researchers seeking to investigate its characteristics and how it evolves over time. Current transducer-based methodologies effectively monitor non-nutritive sucking activity [39]. However, these approaches are associated with high costs, limited suitability for research purposes, and potential interference with the natural sucking behavior itself.

### SUMMARY

The present technology provides a computer implemented systems and methods for detecting NNS by an infant in a video recording. The present technology also provides for determining the start and end times of the NNS in the video recording. Additionally, the present technology provides a computer implemented systems and methods for generating training datasets for the models and convolutional neural networks utilized to detect NNS. The present technology for detecting NNS in a video recording includes creating video segments from the video recording, where the video segments are a predetermined fixed length. For each video segment, action recognition is performed that includes performing facial recognition to determine a facial bounding box for each frame of the video segment. The frames are cropped based on the facial bounding box. For each cropped frame, an optical flow frame is generated of the optical flow direction vectors for each pixel of the cropped frame. Using a convolution network and the optical flow frames, a segment feature vector is determined from the pre-classification feature layer of the convolution network. The segment feature vector corresponding to each video segment is used as input to a dilated convolution network to predict the video segments that include an NNS action and determine the start and end time of the NNS action.

An aspect of the technology is a computer-implemented method for detecting NNS in video. The computer-implemented method includes the following operations: receiving video data of an infant exhibiting an NNS action; determining a sequence of video segments from the video data, wherein the video segments are a fixed length and the sequence of video segments determined from the video data are based on a sliding window of the fixed length and a stride that is less than the fixed length wherein each video segment includes an overlap with sequential neighbor video segments; performing action recognition for each video segment of the sequence of video segments; receiving a sequence of feature vectors corresponding to the sequence of video segments and based on the action recognition, wherein the feature vectors represent features extracted from a pre-classification feature layer of an action recognition network; determining, using a dilated convolution network with the sequence of feature vectors as input, an NNS action prediction for each frame of the video data; and determining a start time and an end time for a NNS action in the video data based on the NNS action prediction for each frame of the video data.

The aspect of technology for the computer-implemented method for detecting NNS in video further includes the following operations for performing the action recognition: receiving a first video segment, the first video segment comprising a plurality of frames; determining a plurality of face bounding boxes capturing a facial region by performing face detection, wherein a face bounding box of the plurality of face bounding boxes corresponds to each frame of the plurality of frames; determining a plurality of cropped frames by cropping each frame of the plurality of frames based on the face bounding box corresponding to each frame of the plurality of frames, wherein each cropped frame of the plurality of cropped frames has a corresponding frame in the plurality of frames; determining optical flow direction vectors for pixels of each cropped frame of the plurality of cropped frames based on calculating dense optical flow between consecutive frames of the plurality of cropped frames; generating a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and determining a segment feature vector, from the pre-classification feature layer of the action recognition network, for the first video segment based on the plurality of optical flow frames.

Another aspect of the technology is a computer-implemented method for generating a NNS training dataset. The computer-implemented method includes the following operations: receiving a plurality of video recordings, wherein the plurality of video recordings are recordings of infants and wherein each video recording includes NNS labeling that identifies a segment of the video recording that includes NNS; and generating the NNS training dataset for training a dilated convolution network as a labeled sequence of feature vectors for each video recording of the plurality of video recordings, wherein generating the labeled sequence of feature vectors for a particular video recording of the plurality of video recordings further comprises: determining a sequence of video segments from the particular video recording, wherein the video segments are a fixed length and the sequence of video segments determined from the particular video recording are based on a sliding window of the fixed length and a stride that is less than the fixed length wherein each video segment includes an overlap with sequential neighbor video segments; performing action recognition for each video segment of the sequence of video segments; receiving a sequence of feature vectors corresponding to the sequence of video segments and based on the action recognition, wherein the feature vectors represent features extracted from a pre-classification feature layer of an action recognition network; and labeling the sequence of feature vectors corresponding to the NNS labeling of the particular video recording.

Another aspect of the technology is a computer-implemented method for generating a non-nutritive sucking NNS training dataset. The computer-implemented method includes the following operations: receiving a plurality of video segments capturing infants, wherein each video segment of the plurality of video segments comprises a plurality of frames and wherein each video segment includes an NNS labelling classification of NNS or non-NNS; generating the NNS training dataset for training an action recognition network as a labeled optical flow frame set for each video segment of the plurality of video segments, wherein generating the labeled optical flow frame set for a particular video segment of the plurality of video segments further comprises: determining a plurality of face bounding boxes capturing a facial region by performing face detection, wherein a face bounding box of the plurality of face bounding boxes corresponds to each frame of the plurality of frames for the particular video segment; determining a plurality of cropped frames by cropping each frame of the plurality of frames based on the face bounding box corresponding to each frame of the plurality of frames, wherein each cropped frame of the plurality of cropped frames has a corresponding frame in the plurality of frames; determining optical flow direction vectors for pixels of each cropped frame of the plurality of cropped frames based on calculating dense optical flow between consecutive frames of the plurality of cropped frames; generating a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and labeling the plurality of optical flow frames corresponding to the NNS labeling classification of the particular video segment.

The technology can be further summarized with the following list of features.
1. A computer implemented method for detecting non-nutritive sucking (NNS) in video, comprising:
   receiving video data of an infant exhibiting an NNS action;
   determining a sequence of video segments from the video data, wherein the video segments are a fixed length and the sequence of video segments determined from the video data are based on a sliding window of the fixed length and a stride that is less than the fixed length wherein each video segment includes an overlap with sequential neighbor video segments;
   performing action recognition for each video segment of the sequence of video segments;
   receiving a sequence of feature vectors corresponding to the sequence of video segments and based on the action recognition, wherein the feature vectors represent features extracted from a pre-classification feature layer of an action recognition network;
   determining, using a dilated convolution network with the sequence of feature vectors as input, an NNS action prediction for each frame of the video data; and
   determining a start time and an end time for a NNS action in the video data based on the NNS action prediction for each frame of the video data.
2. The computer implemented method of feature 1, wherein performing the action recognition further comprises:
   receiving a first video segment, the first video segment comprising a plurality of frames;
   determining a plurality of face bounding boxes capturing a facial region by performing face detection, wherein a face bounding box of the plurality of face bounding boxes corresponds to each frame of the plurality of frames;
   determining a plurality of cropped frames by cropping each frame of the plurality of frames based on the face bounding box corresponding to each frame of the plurality of frames, wherein each cropped frame of the plurality of cropped frames has a corresponding frame in the plurality of frames;
   determining optical flow direction vectors for pixels of each cropped frame of the plurality of cropped frames based on calculating dense optical flow between consecutive frames of the plurality of cropped frames;
   generating a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and
   determining a segment feature vector, from the pre-classification feature layer of the action recognition network, for the first video segment based on the plurality of optical flow frames.
3. The computer implemented method of feature 2, further comprising:
   determining an NNS classification, using the action recognition network, for the first video segment based on the plurality of optical flow frames, wherein determining the NNS classification using the action recognition network further comprises:
      determining a plurality of spatial features corresponding to the plurality of optical flow frames using a conventional 2D convolutional network;
      determining a plurality of frame NNS classifications corresponding to the plurality of spatial features using a temporal 1D convolution network; and
      determining the NNS classification for the first video segment based on the plurality of frame NNS classifications.
4. The computer implemented method of feature 2, wherein determining the face bounding box for each frame of the plurality of frames further comprises:
   determining a first bounding box, based on the face detection, for at least one frame of the plurality of frames; and
   propagating the first bounding box to adjacent frames of the at least one frame.
5. The computer implemented method of feature 4, wherein determining the face bounding box for each frame of the plurality of frames further comprises:
   determining first saliency corners for the first bounding box of the at least one frame; and
   modifying a second bounding box for a subsequent frame of the at least one frame based on tracking the first saliency corners to second saliency corners of the subsequent frame.
6. The computer implemented method of feature 2, wherein determining the face bounding box for each frame of the plurality of frames further comprises:
   determining a trajectory for the plurality of face bounding boxes by applying a moving average filter; and
   modifying the plurality of face bounding boxes to stabilize the facial region by applying the trajectory to each face bounding box of the plurality of face bounding boxes.
7. The computer implemented method of feature 2, wherein generating the plurality of optical flow frames further comprises:
   determining the color value for the pixels of each cropped frame of the plurality of cropped frames by combining the optical flow direction vectors for the pixels of each cropped frame of the plurality of cropped frames with a magnitude for the pixels of each cropped frame of the plurality of cropped frames, wherein the color value is in Hue, Saturation, and Value (HSV) color space.
8. A computer implemented method for generating a non-nutritive sucking (NNS) training dataset, comprising:
   receiving a plurality of video recordings, wherein the plurality of video recordings are recordings of infants exhibiting an NNS action and wherein each video recording includes NNS labeling that identifies a segment of the video recording that includes NNS; and
   generating the NNS training dataset for training a dilated convolution network as a labeled sequence of feature vectors for each video recording of the plurality of video recordings, wherein generating the labeled sequence of feature vectors for a particular video recording of the plurality of video recordings further comprises:
      determining a sequence of video segments from the particular video recording, wherein the video segments are a fixed length and the sequence of video segments determined from the particular video recording are based on a sliding window of the fixed length and a stride that is less than the fixed length wherein each video segment includes an overlap with sequential neighbor video segments;
      performing action recognition for each video segment of the sequence of video segments;
      receiving a sequence of feature vectors corresponding to the sequence of video segments and based on the action recognition, wherein the feature vectors represent features extracted from a pre-classification feature layer of an action recognition network; and
      labeling the sequence of feature vectors corresponding to the NNS labeling of the particular video recording.
9. A computer implemented method for generating a non-nutritive sucking (NNS) training dataset, comprising:
   receiving a plurality of video segments capturing infants exhibiting an NNS action or not exhibiting an NNS action, wherein each video segment of the plurality of video segments comprises a plurality of frames and wherein each video segment includes an NNS labelling classification of NNS or non-NNS;
   generating the NNS training dataset for training an action recognition network as a labeled optical flow frame set for each video segment of the plurality of video segments, wherein generating the labeled optical flow frame set for a particular video segment of the plurality of video segments further comprises:
      determining a plurality of face bounding boxes capturing a facial region by performing face detection, wherein a face bounding box of the plurality of face bounding boxes corresponds to each frame of the plurality of frames for the particular video segment;
      determining a plurality of cropped frames by cropping each frame of the plurality of frames based on the face bounding box corresponding to each frame of the plurality of frames, wherein each cropped frame of the plurality of cropped frames has a corresponding frame in the plurality of frames;
      determining optical flow direction vectors for pixels of each cropped frame of the plurality of cropped frames based on calculating dense optical flow between consecutive frames of the plurality of cropped frames;
      generating a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and
      labeling the plurality of optical flow frames corresponding to the NNS labeling classification of the particular video segment.
10. The computer implemented method of feature 9, wherein determining the face bounding box for each frame of the plurality of frames further comprises:
   determining a first bounding box, based on the face detection, for at least one frame of the plurality of frames; and
   propagating the first bounding box to adjacent frames of the at least one frame.
11. The computer implemented method of feature 10, wherein determining the face bounding box for each frame of the plurality of frames further comprises:
   determining first saliency corners for the first bounding box of the at least one frame; and
   modifying a second bounding box for a subsequent frame of the at least one frame based on tracking the first saliency corners to second saliency corners of the subsequent frame.
12. The computer implemented method of feature 9, wherein determining the face bounding box for each frame of the plurality of frames further comprises:
   determining a trajectory for the plurality of face bounding boxes by applying a moving average filter; and
   modifying the plurality of face bounding boxes to stabilize the facial region by applying the trajectory to each face bounding box of the plurality of face bounding boxes.
13. The computer implemented method of feature 9, prior to determining the optical flow direction vectors for pixels of each cropped frame of the plurality of cropped frames, modifying the plurality of cropped frames by performing random transformations to the plurality of cropped frames, wherein the random transformations include at least one of rotation, scaling, or mirroring.
14. The computer implemented method of feature 9, wherein generating a plurality of optical flow frames further comprises:
   determining the color value for the pixels of each cropped frame of the plurality of cropped frames by combining the optical flow direction vectors for the pixels of each cropped frame of the plurality of cropped frames with a magnitude for the pixels of each cropped frame of the plurality of cropped frames, wherein the color value is in Hue, Saturation, and Value (HSV) color space.
15. A system for detecting non-nutritive sucking (NNS) in video, comprising:
   at least one processor; and
   at least one memory including instructions that, when executed by the at least one processor, cause the system to:
      receive video data of an infant exhibiting an NNS action, the video data being at least 30 seconds in length;
      determine a sequence of video segments from the video data, wherein the video segments are a fixed length and the sequence of video segments determined from the video data are based on a sliding window of the fixed length and a stride that is less than the fixed length wherein each video segment includes an overlap with sequential neighbor video segments;
      perform action recognition for each video segment of the sequence of video segments;
      receive a sequence of feature vectors corresponding to the sequence of video segments and based on the action recognition, wherein the feature vectors represent features extracted from a pre-classification feature layer of an action recognition network;
      determine, using a dilated convolution network with the sequence of feature vectors as input, an NNS action prediction for each frame of the video data; and
      determine a start time and an end time for a NNS action in the video data based on the NNS action prediction for each frame of the video data.
16. The system of feature 15, wherein performing the action recognition, the at least one memory further comprises instructions that, when executed by the at least one processor, further cause the system to:
   receive a first video segment, the first video segment comprising a plurality of frames;
   determine a plurality of face bounding boxes capturing a facial region by performing face detection, wherein a face bounding box of the plurality of face bounding boxes corresponds to each frame of the plurality of frames;
   determine a plurality of cropped frames by cropping each frame of the plurality of frames based on the face bounding box corresponding to each frame of the plurality of frames, wherein each cropped frame of the plurality of cropped frames has a corresponding frame in the plurality of frames;
   determine optical flow direction vectors for pixels of each cropped frame of the plurality of cropped frames based on calculating dense optical flow between consecutive frames of the plurality of cropped frames;
   generate a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and
   determine a segment feature vector, from the pre-classification feature layer of the action recognition network, for the first video segment based on the plurality of optical flow frames.
17. The system of feature 16, wherein the at least one memory further comprises instructions that, when executed by the at least one processor, further cause the system to:
   determine an NNS classification, using the action recognition network, for the first video segment based on the plurality of optical flow frames, wherein determining the NNS classification using the action recognition network further comprises:
      determine a plurality of spatial features corresponding to the plurality of optical flow frames using a conventional 2D convolutional network;
      determine a plurality of frame NNS classifications corresponding to the plurality of spatial features using a temporal 1D convolution network; and
      determine the NNS classification for the first video segment based on the plurality of frame NNS classifications.
18. The system of feature 16, wherein determining the face bounding box for each frame of the plurality of frames, the at least one memory further comprises instructions that, when executed by the at least one processor, further cause the system to:
   determine a first bounding box, based on the face detection, for at least one frame of the plurality of frames; and
   propagate the first bounding box to adjacent frames of the at least one frame.
19. The system of feature 16, wherein determining the face bounding box for each frame of the plurality of frames, the at least one memory further comprises instructions that, when executed by the at least one processor, further cause the system to:
   determine a trajectory for the plurality of face bounding boxes by applying a moving average filter; and
   modify the plurality of face bounding boxes to stabilize the facial region by applying the trajectory to each face bounding box of the plurality of face bounding boxes.
20. The system of feature 16, wherein generating a plurality of optical flow frames, the at least one memory further comprises instructions that, when executed by the at least one processor, further cause the system to:
   determine the color value for the pixels of each cropped frame of the plurality of cropped frames by combining the optical flow direction vectors for the pixels of each cropped frame of the plurality of cropped frames with a magnitude for the pixels of each cropped frame of the plurality of cropped frames, wherein the color value is in Hue, Saturation, and Value (HSV) color space.

### BRIEF DESCRIPTION OF THE DRAWINGS

FIG. 1 is a flowchart illustrating the NNS action recognition and segmentation process including the operations performed by an action recognition component and a segmentation component, in accordance with some embodiments.

FIG. 2A illustrates a pressure transducer pacifier device. While such a tool can provide reliable, high resolution measurements, it is expensive and limited to research use, and could interfere with the natural sucking behavior. The computer vision method described herein is based on spatiotemporal neural networks and enables completely contactless detection and segmentation of NNS activity.

FIG. 2B illustrates an extracted non-nutritive sucking (NNS) signal obtained from the pressure transducer pacifier device illustrated in FIG. 2A.

FIG. 3A illustrates six frames from a dataset that are still frames extracted from the NNS clinical in-crib dataset, consisting of 183 hours of night-time in-crib baby monitor footage from 19 infants. The dataset features timestamp annotations drawn from behavioral coding for NNS activity and pacifier use.

FIG. 3B illustrates six frames from the publicly available NNS in-the-wild dataset, drawn from public sources to complement the clinical dataset with further variety. The dataset features timestamp annotations drawn from behavioral coding for NNS activity and pacifier use.

FIG. 4 illustrates suggested baby monitor placement for study participants for an NNS clinical in-crib dataset. Videos for this particular dataset were shot by parents or caregivers in 2021 and 2022 during the pandemic. They are long and feature a wide variety of natural infant behavior, including napping, sleeping, tossing and turning, crying, and caregiver interactions such as pacifier insertion, patting, removal from the crib, and more, yielding a true-to-life but technically challenging data source.

FIG. 5 illustrates the NNS annotation tool used by behavioral coding teams that may be specifically trained for this task. For the NNS clinical in-crib dataset annotations, duplicate coding and systematic checks were implemented to ensure reliability over the hundreds of hours of footage.

FIG. 6A illustrates the NNS segmentation pipeline, based on aggregating local results of NNS action recognition in sliding windows. Features for each sliding window are extracted using the proposed action-recognition-based feature extractor and then input into the dilated convolution network for frame-based action prediction and achieve action segmentation.

FIG. 6B illustrates the NNS action recognition pipeline, which applies dense optical flow to preprocessed frames and passes features through a convolutional layer followed by a temporal layer to obtain an action prediction based on spatiotemporal information.

FIGS. 7A and 7B illustrate visualizations of the optical flow processing on the NNS clinical in-crib datasets. For each subject (identified by the “R #”), the illustration shows the video frame on the left, a representation of the optical flow field on the right, and the superposition of the two in the middle. FIG. 7A illustrates examples of NNS action in-progress. FIG. 7B illustrates examples of non-NNS action taking place. Thus illustrating the effectiveness of optical flow in discerning the subtle sucking signal. Optical flow can be noisy, for instance, picking up on video encoding artifacts in R3(b).

FIG. 8 illustrates segmentation predictions and ground truth for each 60 second mixed clip from the NNS clinical in-bed dataset, under the sliding window aggregation model configuration and with a confidence threshold of 0.9, boosting precision at the cost of recall.

FIG. 9 illustrates a comparison of optical flow results from four widely used algorithms on a video from the NNS clinical in-crib dataset, illustrating the ability of Coarse2Fine to most cleanly isolate the NNS movement from background noise. For each method, the video frame is shown on the left, the optical flow field in the middle, and the superposition of the two on the right.

### DETAILED DESCRIPTION

The methods and techniques described herein introduce a multi-stage process using convolutional neural networks to identify instances of NNS in a video recording of an infant exhibiting an NNS action and predict the start and end times of each NNS action instance. In an embodiment, the infant is sleeping, but in other embodiments it can exhibit other behaviors or positions. In embodiments, the duration or length of the video recording is sufficient to capture one or more NNS actions; for example, the video can have a duration of at least 10 seconds, at least 20 seconds, at least 30 seconds, at least 60 seconds, at least 100 seconds, or longer. The objective of the methods and techniques described herein is to facilitate broad applications in automatic screening and telehealth for infants. There is a strong emphasis on achieving high precision, ensuring the reliable extraction of periods of sucking activity for subsequent analysis by human experts.

The technical contributions of the methods and techniques described herein encompass two key aspects: firstly, addressing the fine-grained NNS action recognition challenge, which involves classifying video clips (e.g., 2.5-second video clips) into NNS or non-NNS categories; and secondly, tackling the broader NNS action segmentation problem, which entails identifying frames that exhibit NNS activity in at least minute long video clips. The action recognition method described herein relies on spatiotemporal learning through convolutional long short-term memory networks. To overcome the limitations posed by the scarcity and reliability issues of real-world baby monitor footage, the pipeline described herein incorporates a specialized infant pose state estimation technique. This method detects the infant's face, narrows the focus to the mouth and pacifier region, and enhances it using dense optical flow. For action segmentation, both manually-tuned and learning-based approaches are explored for aggregating and filtering the outcomes of local NNS recognition. The methodology described herein serves as the foundation for a fully automated computer vision assessment of NNS, enabling the extraction of critical sucking signal characteristics, including frequency, duration, amplitude, and temporal pattern.

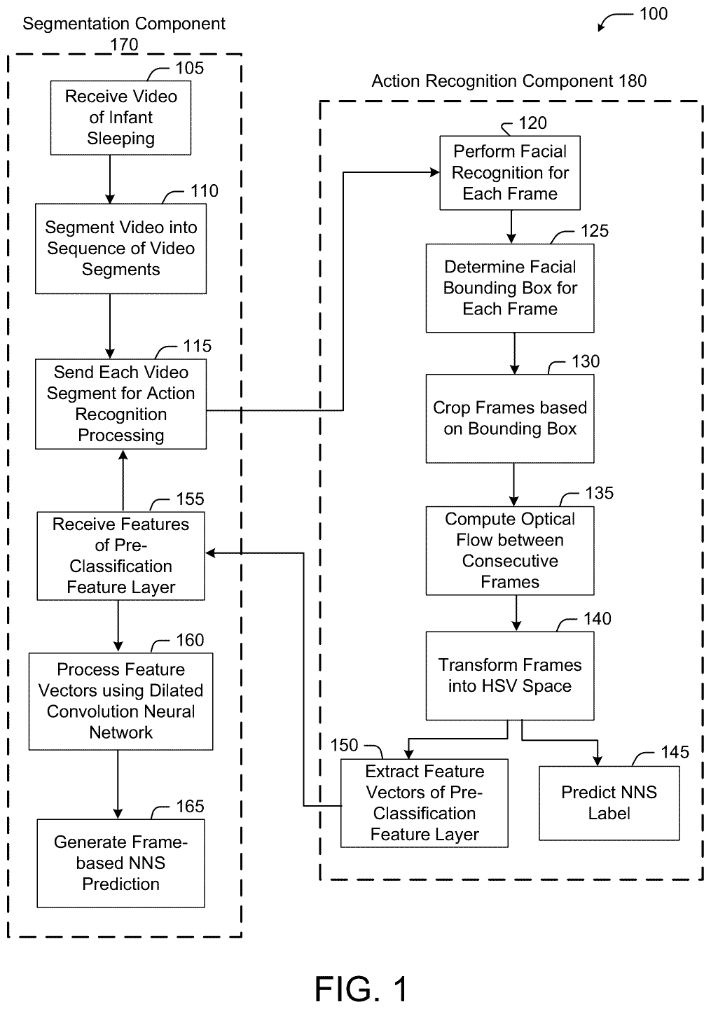

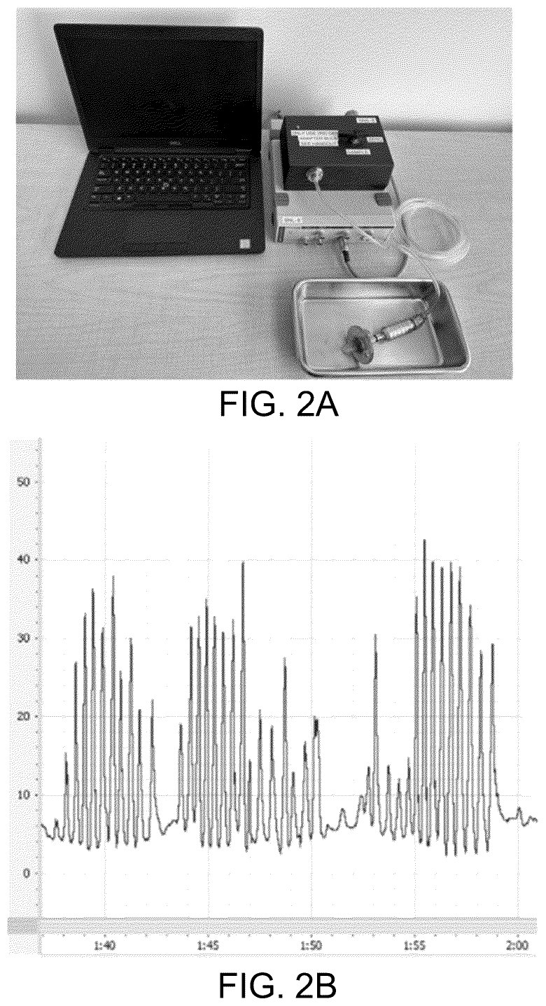

FIG. 1 is a flowchart illustrating the NNS action recognition and segmentation process 100, in accordance with some embodiments. The NNS action recognition and segmentation process 100 may be implemented on a computer. The computer may include a hardware processor (e.g., a central processing unit (CPU), a graphics processing unit (GPU), a hardware processor core, or any combination thereof), a main memory, and a static memory, some or all of which may communicate with each other via an interlink (e.g., bus). The computer may further include a display unit, an alphanumeric input device (e.g., a keyboard), and a user interface (UI) navigation device (e.g., a mouse). In an example, the display unit, input device, and UI navigation device may be a touch screen display. The computer may additionally include a storage device (e.g., drive unit). The storage device may include a machine readable medium on which is stored one or more sets of data structures or instructions (e.g., software) embodying or utilized by any one or more of the techniques or functions described herein. The instructions may also reside, completely or at least partially, within the main memory, within static memory, or within the hardware processor during execution thereof by the computer.

The NNS action recognition and segmentation process 100 may be executed by the processor using instructions that include an action recognition component 180 and a segmentation component 170. At operation 105, the segmentation component 170 may receive a video recording of an infant sleeping. The video recording may be in a digital format and stored in memory. The video recording may capture primarily the face and/or head of the infant. At operation 110, the video recording may be segmented into a sequence of video segments. The video segments may be a predetermined fixed length (e.g., 1 second, 2.5 seconds, etc.). The segmentation of the video recording may be based on one of several different techniques, such as tiling or sliding window, as described in detail below. At operation 115, the segmentation component 170 sends each video segment from the sequence of video segments to the action recognition component 180.

For each video segment, the action recognition component 180 may determine if the video segment include an instance of NNS action or does not include an instance of NNS action (e.g., NNS or non-NNS). Each video segment includes at least one frame. The operations of the action recognition component 180 are performed for each frame of the video segment. At operation 120, the action recognition component 180 may perform facial recognition for each frame of the video segment. Based on the facial recognition, at operation 125, a facial bounding box is defined for each frame. The facial bounding box encloses the facial region of the infant. At operation 130, the action recognition component 180 crops each frame based on the facial bounding box and thus creating a new set of cropped frames.

At operation 135, the action recognition component 180 computes the short-time dense optical flow between consecutive frames which results in an optical flow direction vector for each pixel of a given frame. At operation 140, the action recognition component 180 transforms the optical flow results into the Hue, Saturation, and Value (HSV) color space by combining the optical flow direction vector and the magnitude of each pixel. This generates a set of frames where the visible motion between frames is amplified by coloring facial areas where movement occurs so that the subtle movements of NNS may be recognized.

The action recognition component 180 may use a 2D-1D convolutional neural network (e.g., spatiotemporal module) to predict a label (i.e., classify) for the video segment, such as NNS or non-NNS. At operation 145, the action recognition component 180 may predict the NNS label for the video segment. Additionally, as part of the NNS action recognition and segmentation process 100, the segmentation component 170 may be configured to use feature vectors from a pre-classification feature layer of the 2D-1D convolutional neural network. At operation 150, feature vectors from the pre-classification feature layer of the 2D-1D convolutional neural network are extracted.

At operation 155, the segmentation component 170 receives the extracted features from the pre-classification feature layer for each video segment processed by the action recognition component 180. At operation 160, the segmentation component 170 processes the feature vectors from the pre-classification feature layer using a dilated convolutional neural network. At operation 165, a frame based NNS prediction is generated based on the processing of the feature vectors using the dilated convolutional neural network. The frame based NNS prediction identifies the portion(s) of the video recording, including the start and end time, that include instance(s) of NNS action.

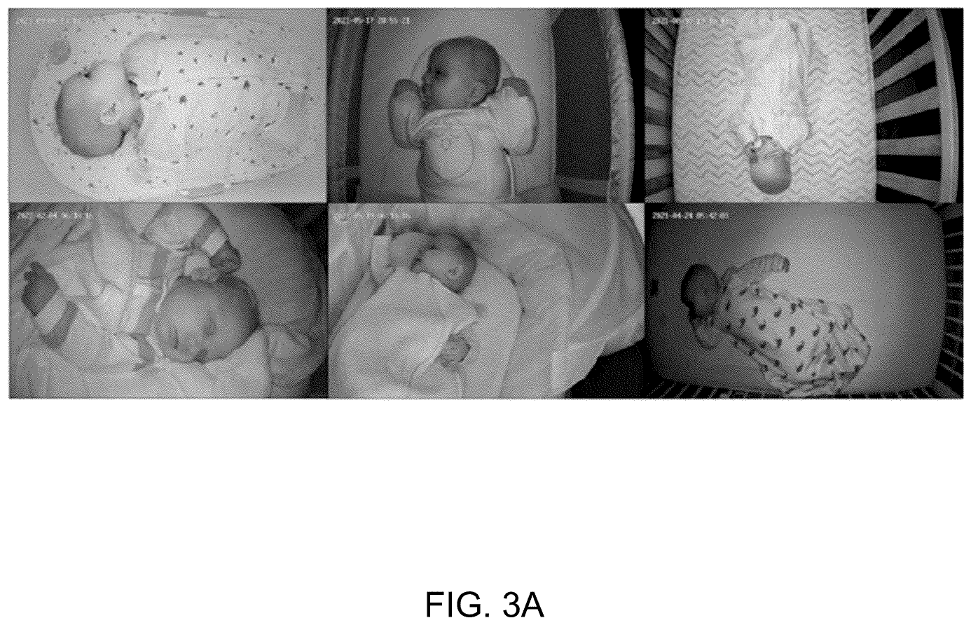

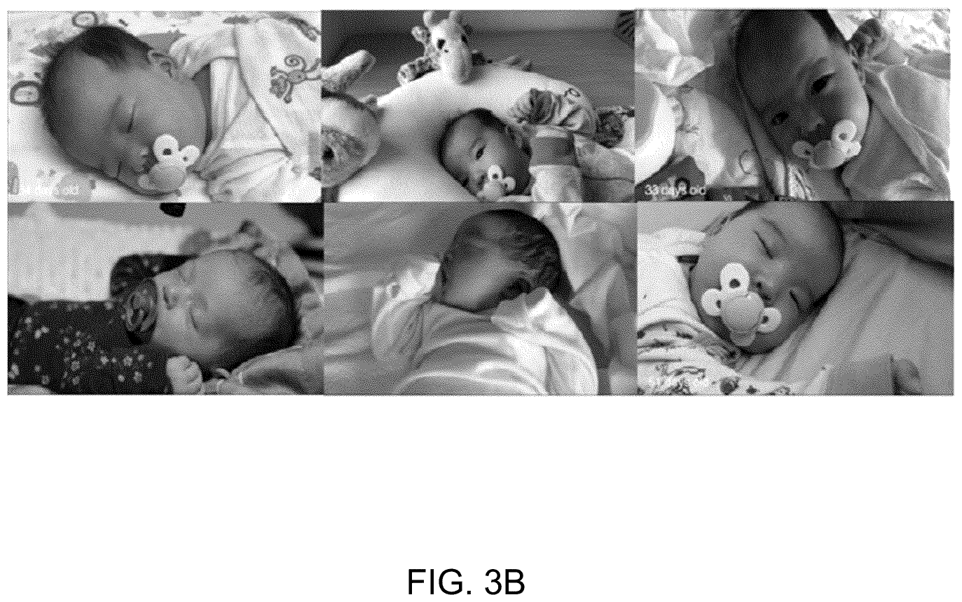

The methods and techniques described herein include two new datasets: the NNS clinical in-crib dataset, consisting of 183 hours of nighttime in-crib baby monitor footage collected from 18 infants and annotated for NNS activity and pacifier use, and the NNS in-the-wild dataset, consisting of 10 naturalistic infant video clips annotated for NNS activity. FIGS. 3A and 3B display sample frames from both datasets.

The methods and techniques described here include the creation of infant video datasets manually annotated with NNS activity, including an additional subset with clips featuring challenging infant poses, motions, and conditions; the development of an NNS classification system using a convolutional long short-term memory network, aided by infant domain specific face localization, video stabilization, and customized signal enhancement, with new performance tests on the challenging dataset; an exhaustive experimental comparison of the classification method with various spatiotemporal models; and successful NNS segmentation on longer clips by aggregating local NNS recognition, both with a manually-tuned sliding windows approach, and a deep-learning based approach using a dilated convolutional network.

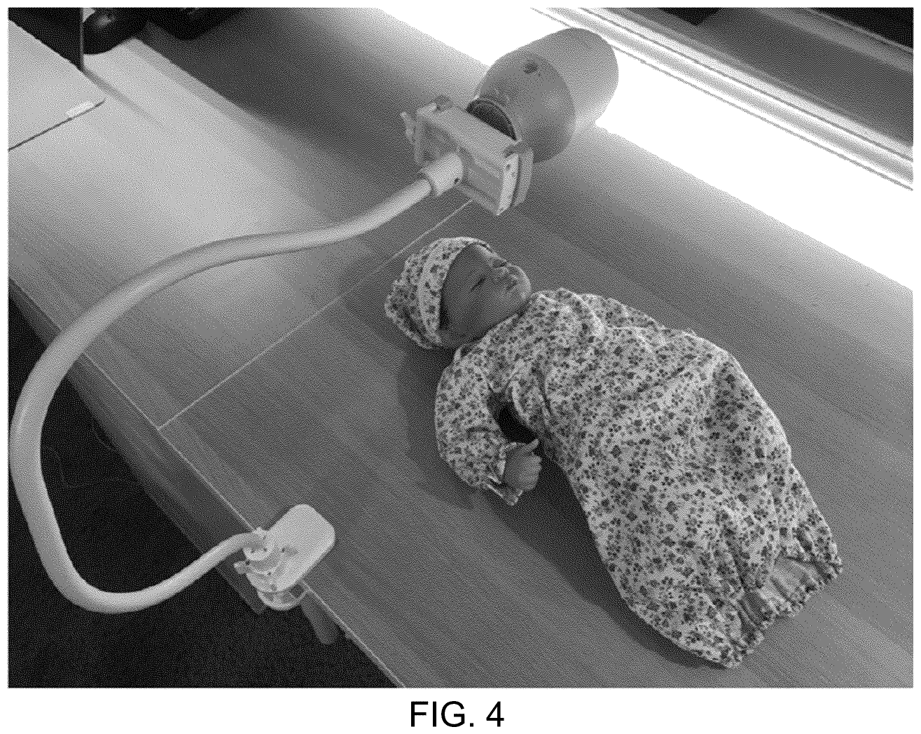

There are two existing methods for qualitative capture of nonnutritive sucking data. The first is a pressure-sensor-equipped pacifier, developed in the lab [39], a specialized research grade device that enables continuous capture of the non-nutritive sucking signal, including suck strength, duration, and frequency, and, by inference, information about bursts of sucks. The second NNS measurement system is the NTrainer System [27] and intended to enhance NNS and feeding development in premature and newborn infants. This employs the Actifier, a specialized system using a Honeywell pressure transducer integrated with a custom Delrin receiver and a sterile smoothie silicone pacifier, to measure lip, tongue, and jaw forces during sucking. Both systems are prohibitively costly for widespread deployment, with the first pacifier developed specifically for research use. The camera-based system, illustrated in FIG. 4, has a significantly lower cost. Aside from the accessibility afforded by its low cost, the system described herein has the advantage of operating entirely contactless—the conventional contact-based systems may interfere with the very infant sucking patterns they are intended to observe. Other methods include a contactless method for collecting NNS data [13]. This approach automatically tracks the baby's jaw landmarks in video footage via 2D facial landmarks, then employs a 3D morphable model (3DMM) [14] to generate 3D facial landmarks. Then suck cycles and NNS pattern frequency are computed from the denoised landmark movement signals. However, the 3DMM model is only learned from adult face data, limiting its accuracy, given the domain gap between infant and adult faces [32]. The overall pipeline is inference-based, with no component trained on infant or NNS data, and is only tested on 10 short video samples without NNS annotations.

Action recognition or action classification, which may be used interchangeably, is the task of assigning a class label from a fixed list to a short video clip. The actions are typically short and well-defined, like riding a bike or climbing stairs. Datapoints consist of short video clips, often on the order of a few seconds long, trimmed to contain a single unequivocal action. Leveraging the success of 2D convolutional neural networks (CNNs) in image analysis, many action recognition methods have been built upon this robust CNN architecture. Many existing video-based action recognition models are simply built on top of image classification models, which are tailored to process video by replacing 2D- with 3D convolution, such as 3D ResNet [16] that extended the success of 2D convolutional networks to three-dimensional spatiotemporal data, laying the foundation for video understanding. To better address the temporal queue yet preserve the spatial feature, I3D [4] introduced a pivotal concept by fusing information from two streams: RGB and optical flow, using two 2D models with identical network structures, thereby enhancing action recognition performance through an integrated approach. Furthermore, X3D [10], has made significant progress towards efficient video architecture that presents new insights for turning a 2D architecture into a 3D one by progressively expanding it along multiple axes, such as width, depth, and time.

A limitation is evident in the aforementioned CNN-based methodologies pertains to their predominant application in addressing coarse-grained action recognition tasks (e.g., playing golf, tennis. etc.), wherein they have demonstrated remarkable performance primarily attributable to the pre-training of their 2D base models on large-scale coarse-grained image datasets like ImageNet [5]. The present objective is the classification of short video clips depicting infants based on the subtle presence or absence of non-nutritive sucking (NNS) behavior—a nuanced facial action characterized by minute movements around the mouth region. Despite endeavors to adapt the aforementioned approaches for NNS action classification (as described below), there is a pronounced performance degradation in comparison to their proficiency in coarse-grained action recognition, primarily due to the presence of a substantial action domain gap. In response to the subtlety inherent to NNS actions, the approach adopted is akin to I3D, leveraging optical flow input to account for minuscule motion patterns. Subsequently, this framework is expanded upon by incorporating 2D convolutional neural networks into the temporal dimension, allowing for the processing of spatiotemporal data. This augmentation involved the integration of sequential networks, specifically long short-term memory (LSTM) networks, subsequent to frame-wise convolutions, thereby fortifying the model's ability to capture medium-range temporal dependencies.

Temporal action segmentation is a broader task in video comprehension. The goal is to take a longer video consisting of a diverse spectrum of activities, partition it into a set of intervals of arbitrary duration in time, and assign action classes to each interval. Recent advancements in this domain have predominantly adopted the multiple-instance learning (MIL) paradigm [21], wherein the entirety of an untrimmed video is conceptualized as a labeled bag encompassing numerous unlabeled instances. Within this framework, a common approach involves the treatment of video snippets as individual instances, utilizing a pre-trained feature extractor rooted in action recognition models. This feature extractor is employed in conjunction with a sliding window mechanism to construct an input feature sequence, which is subsequently used to train a segmentation model tasked with classifying the labels associated with the snippets within the sequence, ultimately enabling the precise segmentation of actions within the video.

Following the MIL paradigm, the MS-TCN [8] pioneered the concept of multi-stage temporal convolutions, offering a hierarchical framework for capturing long-range temporal dependencies by processing video sequences in a multi-scale fashion. Building upon this foundation, Global2Local [11] introduced an innovative perspective by integrating global and local context modeling, enhancing the network's ability to discern intricate spatiotemporal patterns. The logical continuum culminates with ASFormer [34], where the transformer architecture is adapted to spatiotemporal video data so that the strengths of transformers in capturing global context are leveraged but maintaining local spatiotemporal information through tokenization strategies, thereby bridging the gap between global and local representations.

The aforementioned methodologies all incorporated a pre-trained I3D-based feature extractor as a preliminary step for feature sequence preparation in their training pipelines. The proposed action recognition model, in contrast to the previously suggested aggregation-based model [37], includes a modification of the MS-TCN model. Subsequently, an extensive evaluation was conducted employing the features extracted by the pre-trained action recognition model. To discern the efficacy and comparative performance of this model against the other state-of-the-art methods, all of which were fine-tuned on the identical set of features, a comparative analysis was conducted. This rigorous evaluation aims to shed light on the suitability and performance characteristics of the deep learning based model in contrast to previously advocated aggregation-based approaches, contributing to a more comprehensive understanding of action recognition in the context of video analysis.

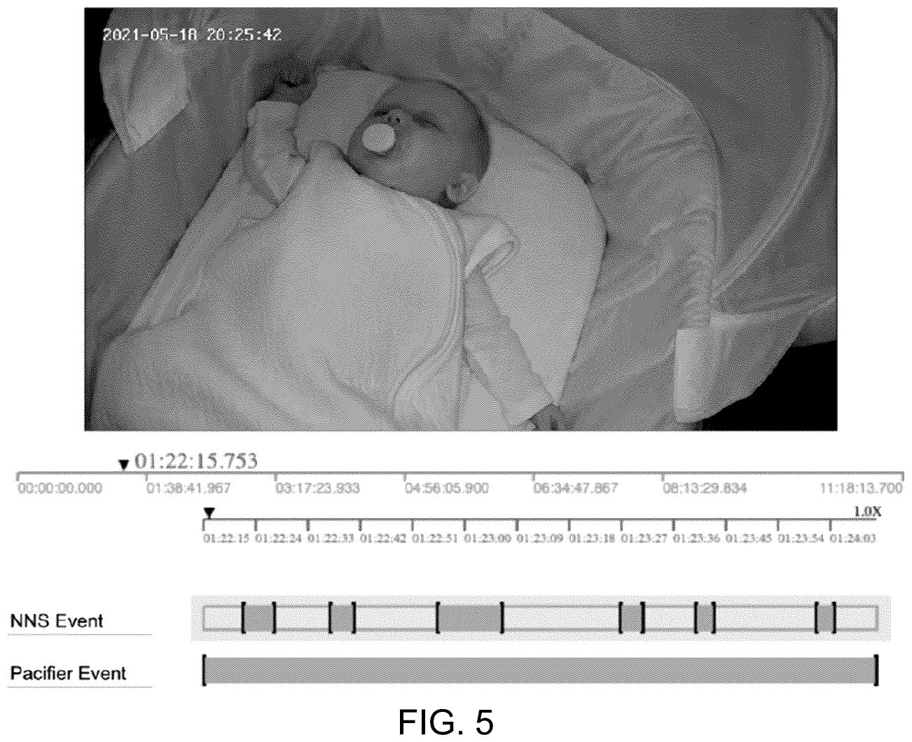

The primary dataset is the NNS clinical in-crib dataset, collected using the toolkit shown in FIG. 4 consisting of 183 hours of baby monitor footage collected from 18 infants during overnight sleep sessions by a clinical neurodevelopment team [37]. The participants ranged from 4-11 months old, the average age is 7 months old. Videos were shot in-crib with the baby monitors set up by caregivers, under low light triggering the monochromatic infrared mode. Tens of thousands of timestamps for NNS and pacifier activity were placed using the annotation tool shown in FIG. 5, by two trained behavioral coders per video. For NNS, the definition of an event segment was taken to be an NNS burst: a sequence of sucks with <1 second gaps between them. The subsequent study was restricted to NNS during pacifier use, which was annotated more consistently. Cohen K annotator agreement of NNS events during pacifier use (among 10 pacifier-using infants) averaged 0.83 in 10 second incidence windows, indicating strong agreement by behavioral coding standards, but further manual selection was performed to increase precision for machine learning use. The study was enriched with a publicly available NNS in-the-wild dataset of 14 YouTube videos featuring diverse lighting, angles, and infant demographics, with lengths ranging from 1 to 30 minutes, subject to the same meticulous annotations and ethical terms as the NNS clinical in-crib dataset.

To demonstrate the reliability of the annotations, the Cohen κ inter-rater reliability scores is provided for each pair of annotators' behavioral coding, per infant video. Since annotators may not agree on the number of events in any given period, Cohen κs cannot be computed directly on the timestamp data. Instead, a common practice from behavioral coding in psychology is adhered and convert each coder's annotations for a single event type (NNS or pacifier) in a video to a binary time sequence representing uniform windows in the runtime, with 1 assigned to windows which overlap temporally with at least one event of that type, and 0 assigned to the remaining windows. Both the fine-grained windows of 0.1 second, which contain one video frame each, as well as the coarser windows of 10 seconds, which is more in line with conventions in behavioral coding, are considered given the imprecision and differences in interpretation built into human behavioral assessments. The Cohen κ scores for the events considered as time sequence over both 0.1 second and 10 second windows, aggregated across all infants in this training and test data, is reported in Table 1. In addition to raw NNS and pacifier events, the table also shows agreement for the derived annotation of NNS events occurring only during pacifier events. Such NNS action is far more regular and reliably codable, and hence the video segmentation efforts are restricted to those events alone. The interpretation of κ scores is subjective, but the levels achieved by the pacifier annotations would typically be characterized as indicating “near perfect” agreement; the NNS-with-pacifier annotation scores could be considered “weak” or “moderate” agreement under the harsh 0.1 second intervals, and “strong” or “almost perfect” under the 10 second intervals. Given the inherent difficulty of NNS annotation, the sheer amount of runtime of the video data, and the subsequent success in using the data for the segmentation task, these annotation efforts represent a hard-earned success.

TABLE 1
Cohen κ inter-rater reliability scores for behavioral coding
between pairs of annotators, for NNS activity, pacifier use,
and NNS activity during pacifier usage, in the NNS clinical
in-crib dataset. The κ scores are computed after converting
start and end timestamp data to binary time series based on
incidence within uniform windows of the specified lengths.

| Event | Window (s) | Mean κ | Interpretation | SD κ |
|---|---|---|---|---|
| NNS (all) | 0.1 | 58.0 | Weak | 5.2 |
| NNS during pacifier | 0.1 | 69.2 | Moderate | 7.8 |
| usage | | | | |
| Pacifier usage | 0.1 | 98.0 | Almost perfect | 2.9 |
| NNS (all) | 10 | 66.4 | Moderate | 4.4 |
| NNS during pacifier | 10 | 82.8 | Strong | 9.5 |
| usage | | | | |
| Pacifier usage | 10 | 98.1 | Almost perfect | 2.9 |

The Cohen κ agreement between two raters' binary classifications on a set is defined as κ:=(P₀−Pₑ)/(1−Pₑ), where P₀ is the observed portion of agreements in the set and Pₑ is the estimated probability of chance agreement, itself defined by Pₑ:=P₀P₁+(1−P₀)(1−P₁), with P₀ and P₁ being the positive assignment rate for each respective rater. It is intended to measure the level of agreement between two raters' assessments while taking into account chance agreements. The following suggested interpretations of agreement strength are adopted based on κ score: 0-0.2 means no agreement, 0.21-0.39 minimal, 0.40-0.59 weak, 0.60-0.79 moderate, 0.80-0.90 strong, and >0.90 almost perfect [23].

Table 2 displays statistics derived from the NNS and pacifier annotations for the 10 subjects, with the NNS events restricted to those annotated during pacifier events (according to the same annotator), based on scientific interests. As expected, there is wide variation in both NNS and pacifier event count and average duration per subject, with for instance the NNS count ranging from 2.3 to 60.4 per hour, and NNS duration from 0.1 to 4.5 minutes per hour. The average length of an NNS event (a burst of sucks) per subject is somewhat more uniform, ranging from 3.2 to 8.1 seconds.

TABLE 2
Biographical data and NNS and pacifier event statistics for the 10 pacifier-using infants from the NNS clinical in-crib
study, six of whom engaged in enough NNS activity for use in machine learning. Age is at time of video capture, BGA
the birth gestational age, BWt the birth weight, Dur the cumulative event duration, C- κ the Cohen κ annotator
agreement (incidence on 10 second windows), Ct the count, and Len the length of individual events. Biographical data
are self-reported (hence whole numbers), and event data are averaged from the two annotators (hence fractional counts).

| | Biographical data | | | | Vid | NNS events (During pacifier use) | | | | | | Pacifier events | | | | | |
|---|---|---|---|---|---|---|---|---|---|---|---|---|---|---|---|---|---|
| | | Age | BGA | BWt | Dur | | Ct | Ct/h | Dur | Dur/h | | | Ct | Ct/h | Dur | Dur/h | Len |
| Sbj | Sex | d | wk | oz | h | C-κ | # | #/h | min | min/h | Lens | C-κ | # | #/h | min | min/h | min |
| R1★ | M | 100 | 40 | 130 | 10.9 | 0.74 | 636.0 | 58.4 | 39.5 | 3.6 | 3.9 | 0.92 | 13.0 | 1.2 | 219.5 | 20.1 | 16.9 |
| R3★ | F | 98 | 39 | 106 | 11.3 | 0.69 | 490.5 | 43.4 | 51.2 | 4.5 | 6.3 | 0.98 | 10.0 | 0.9 | 270.0 | 23.9 | 27.3 |
| R7★ | F | 103 | 39 | 109 | 13.5 | 0.91 | 817.0 | 60.4 | 60.7 | 4.5 | 4.4 | 1.00 | 5.0 | 0.4 | 214.1 | 15.8 | 44.6 |
| R9 | M | 82 | 40 | 145 | 3.1 | 0.83 | 18.0 | 5.8 | 1.8 | 0.6 | 6.4 | 1.00 | 9.0 | 2.9 | 4.5 | 1.4 | 0.5 |
| R10★ | F | 114 | 39 | 121 | 5.0 | 0.90 | 92.5 | 18.6 | 5.2 | 1.1 | 3.6 | 1.00 | 7.0 | 1.4 | 28.7 | 5.8 | 4.1 |
| R12 | F | 112 | 41 | 101 | 13.1 | 0.96 | 79.5 | 6.1 | 6.3 | 0.5 | 4.8 | 0.99 | 3.5 | 0.3 | 14.3 | 1.1 | 4.2 |
| R15 | F | 102 | 40 | 110 | 14.7 | 0.86 | 106.0 | 7.2 | 14.1 | 1.0 | 8.1 | 0.99 | 7.0 | 0.5 | 52.1 | 3.6 | 8.1 |
| R18★ | F | 142 | 37 | 99 | 6.3 | 0.84 | 115.0 | 18.2 | 6.4 | 1.0 | 3.3 | 0.99 | 4.0 | 0.6 | 39.3 | 6.2 | 10.5 |
| R23 | F | 151 | 42 | 106 | 12.8 | 0.79 | 30.0 | 2.3 | 1.6 | 0.1 | 3.2 | 0.94 | 7.5 | 0.6 | 8.9 | 0.7 | 1.2 |
| R24★ | M | 120 | 39 | 129 | 10.7 | 0.80 | 527.5 | 49.4 | 67.2 | 6.3 | 8.1 | 0.97 | 6.5 | 0.6 | 232.3 | 21.7 | 35.9 |
| Mean | — | 112.4 | 39.8 | 115.6 | 10.1 | 0.83 | 291.2 | 27.0 | 25.4 | 2.3 | 5.2 | 0.98 | 7.2 | 0.9 | 108.4 | 10.0 | 15.3 |
| Std | — | 20.8 | 1.4 | 15.0 | 3.9 | 0.08 | 295.0 | 23.4 | 26.3 | 2.2 | 1.9 | 0.03 | 2.9 | 0.8 | 110.0 | 9.3 | 15.5 |
| Mean★ | — | 112.8 | 38.9 | 115.7 | 9.6 | 0.81 | 446.4 | 41.4 | 38.4 | 3.5 | 4.9 | 0.98 | 7.6 | 0.8 | 167.3 | 15.6 | 23.3 |
| Std★ | — | 16.4 | 1.0 | 12.9 | 3.3 | 0.09 | 288.8 | 18.9 | 26.9 | 2.1 | 1.9 | 0.03 | 3.4 | 0.4 | 105.1 | 7.9 | 15.5 |

From the hours-long annotated footage, the following reference datasets are curated to support classification and segmentation tasks, guided by the above reliability and statistical considerations. While the NNS annotations may be considered strongly reliable based on behavioral coding standards, further filtering is necessary to reach sufficient reliability on the split-second level typically desirable in machine learning. But given rarity of NNS activity (0.1-4.5 min/h), positive examples have to be over-represented in order to provide sufficient data for training or support statistically significant conclusions for testing.

From each of the NNS in-crib and in-the-wild datasets, 2.5 second clips are extracted for the classification task and 60 second clips for the segmentation task. In the NNS clinical in-crib dataset, attention was restricted to six infant videos containing enough NNS activity during pacifier use for meaningful clip extraction. From each of these, up to 80 2.5 second clips were randomly selected consisting entirely of NNS activity and 80 2.5 second clips containing non-NNS activity for classification, for a total of 960; and five 60 second clips featuring transitions between NNS and non-NNS activity for segmentation, for a total of 30; redrawing if available when annotations were not sufficiently accurate. In the NNS in-the-wild dataset, it was restricted to five infants exhibiting sufficient NNS activity during pacifier use, from which 38 2.5 second clips each of NNS and no NNS activity were selected for classification, for a total of 76; and from 2 to 26 60 second clips of mixed activity from each infant for segmentation, for a total of 39; again redrawing in cases of poor annotations.

During the annotation process of the NNS in-crib dataset, several cases of NNS activity were identified that were hard to distinguish from non-NNS activity, primarily due to the background movements, such as the infant's crib swinging in the video frame. To enable a specific study of such tricky scenarios, a new challenging subset of the NNS clinical in-crib dataset is isolated, consisting of 120 2.5 second videos drawn evenly from the six final subjects. Training and testing on this dataset gives a broader sense of performance under difficult real-world conditions.

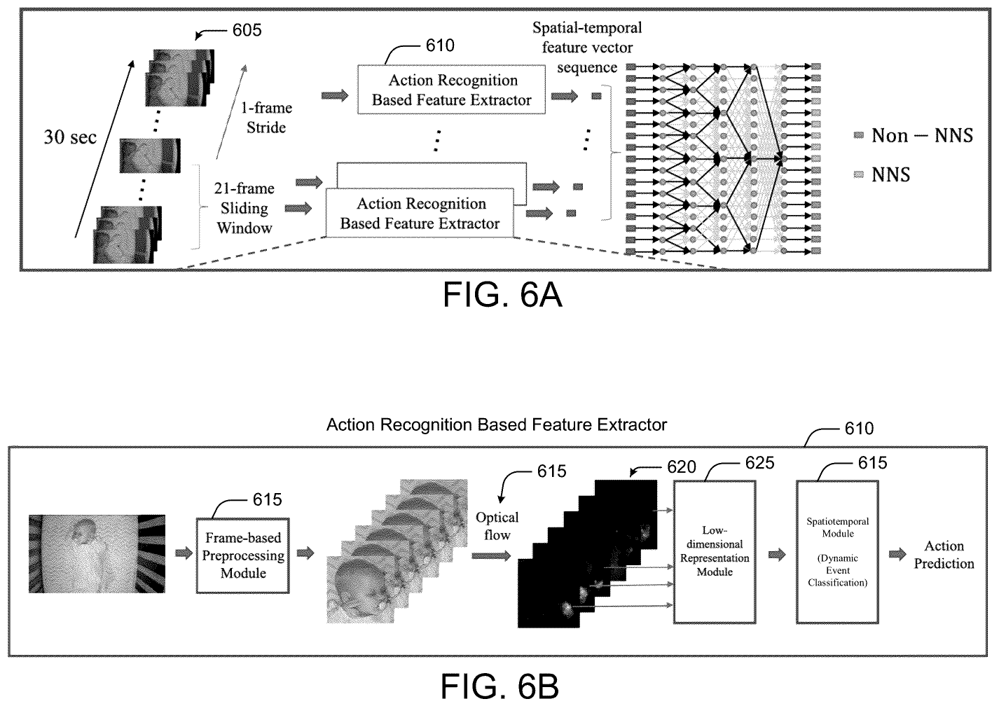

The two-stage NNS action segmentation pipeline, as shown in FIGS. 6A and 6B, is designed to process extended videos featuring infants using pacifiers and predict the timestamps at which NNS events occur throughout the entire video. Input videos of arbitrary length are organized into shorter segments 605 via sliding windows, 2.5 seconds in length. In the first stage, the 2.5 second windows are classified into NNS or non-NNS classes using the NNS action recognition module 610 (e.g., action recognition based feature extractor). In the second stage, these classification signals are amalgamated to generate a segmentation outcome for the whole video, consisting of a list of start and end timestamps for NNS events.

The action recognition module 610 includes a frame-based preprocessing step, followed by analysis via a spatiotemporal neural network. The preprocessing includes the following steps in sequence. All three steps are used to produce training data for the subsequent spatiotemporal classifier (e.g., spatiotemporal module 630), but during inference, the data augmentation step is not applicable and is omitted.

Smooth Facial Crop The frame-based preprocessing module 615 may use the RetinaFace face detector [6] may be used to analyze frames within each video clip until a face bounding box is located. The frame-based preprocessing module 615 may propagate this bounding box to adjacent frames using the Minimum Output Sum of Squared Error (MOSSE) tracker [2]. To enhance the consistency of the facial bounding box sequence and mitigate temporal gaps, the frame-based preprocessing module 615 may identify saliency corners [29] in the initial frame and track them to the subsequent frame employing the Lucas-Kanade optical flow algorithm [19]. The trajectory's smoothness is further enhanced by the frame-based preprocessing module 615 applying a moving average filter and then applying this trajectory to each bounding box, thereby stabilizing the facial region. Finally, the frame-based preprocessing module 615 crops the raw input video using this smoothed bounding box, resulting in a video featuring only the face.

Data Augmentation During the video preprocessing stage, as part of training data generation for the spatiotemporal classifier (e.g., spatiotemporal module 630), random transformations are introduced to the face-cropped video. These transformations include actions like rotations, scaling adjustments, and flipping (mirroring). This augmentation process aims to enhance the model's generalizability, especially in scenarios where there is limited data available.

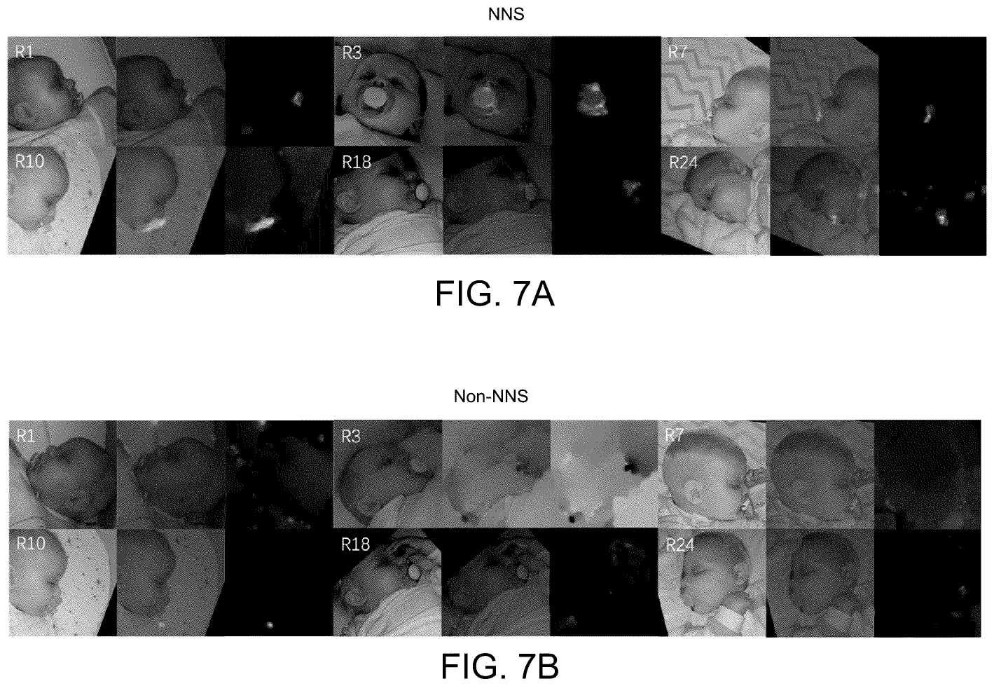

Optical Flow Following the trimming and augmentation steps, the short-time dense optical flow 515 [18] is computed between consecutive frames. The optical flow results 620 are then transformed into the Hue, Saturation, and Value (HSV) color space by combining the optical flow direction vector and the magnitude of each pixel. This process accentuates the visible motion between frames, amplifying subtle NNS movements, as demonstrated in FIG. 7A.

The action recognition module 610 may include a low dimensional representation module 625. Feature extraction, such as from a layer of a model, may serve as a module that reduces the dimensionality of the data into a representation optimized for the final inference model. This feature extraction process ensures that the most relevant features are retained while minimizing computational complexity. The low dimensional representation module 625 may extract features that are used as part of the action segmentation process.

After these preprocessing steps, the resulting optical flow video frames are passed to a spatiotemporal module 630, which predicts an action class label (either NNS or non-NNS). The spatiotemporal module 630 may perform dynamic event classification. Dynamic event classification may involve analyzing segments of videos rather than individual frames. The consideration of both spatial and temporal data, provides for better understanding and classifying dynamic events within the video segments. The structure of the spatiotemporal module 630 is a 2D-1D convolutional network: individual frames are passed into a conventional (2D) convolutional neural network, and the resulting spatial features for each frame are passed into a temporal (1D) convolution network for final classification. In experiments (see Table 8), this worked more effectively than two-stream or 3D convolutional methods.

There may be two types of methods for amalgamating local NNS action recognition outcomes into a global NNS action segmentation result, the first based on simple aggregations of the local classification results, and the second a learned model which uses the features generated by the local classifier.

The aggregation methods described herein work directly with the binary classification results on the 2.5 second sliding windows. This window size—26 frames of the 10 Hz footage—was chosen to be small enough to allow for relatively fine-grained segmentation results, while at the same time large enough to allow some flexibility for human annotation subjectivity and variation in reaction time. By working with sliding windows with 0.5 second strides, segmentation results may be produced with 0.5 second effective resolution. These considerations lead naturally to the following three aggregation methods:

Tiled 2.5 second windows precisely tile the length of the video with no overlaps, and the classification outcome for each window is taken directly to be the segmentation outcome for that window.

Sliding 2.5 second windows are slid across with 0.5 second strides, and the classification outcome for each window is assigned to its (unique) middle-fifth 0.5 second segment as the segmentation outcome.

Smoothed 2.5 second windows are slid across with 0.5 second strides, the classification confidence score for each window is assigned to its middle-fifth 0.5 second segment, a 2.5 second moving average of these confidence scores are taken, then the averaged confidence scores are thresholded for the final segmentation outcome.

The key feature of the learned action segmentation model lies in the cascading dilation of its convolutional layers, depicted schematically in FIG. 6A and technically as above. Rather than working with the final action recognition classification output, as the aggregation methods do, the learned model works with the features provided by the pre-classification feature layer of the spatiotemporal action recognition network. Specifically, inspired by the concept of a multi-stage temporal convolutional network (MS-TCN) [8], the dilated convolution models are constructed to integrate the local features from the classifier. The learned action segmentation model is a modification of the single-stage temporal convolutional network (SS-TCN), designed for action segmentation [8], which itself is inspired by the WaveNet model [25] for raw audio waveform generation.

The learned action segmentation model processes a fixed-length sequence of feature vectors x₀, each representing a point in time within a sequence of length T (specifically T=575, derived from analyzing 60 second video clips using 2.5 second windows with 0.1 second strides). This sequence undergoes initial dimension reduction via a 1D convolutional layer, followed by several 1D convolutional layers that maintain the sequence length but transform the features. The transformed sequence x_{L} is then passed through another 1D convolutional layer and a softmax layer to yield class probabilities y. A distinctive aspect of the model is the expanding dilation in its convolutional layers, enhancing its ability to capture features across different scales.

Namely, while each convolutional layer Hₗ has a kernel kₗ of fixed width of 3, the receptive field is essentially doubled at each layer, so for instance, H₁ acts locally by convolving k₁*(x₀^{t-1}, x₀^{t}, x₀^{t+1}) [symbol] x₁^{t}, H₂ acts locally by k₂*(x₁^{t-2}, x₁^{t} , x₁^{t+2}) [symbol] x₂^{t}, and in general, Hₗ acts locally via kₗ*(xₗ₋₁^{t-2}^{^{l−1}}, xₗ₋₁^{t}, xₗ₋₁ ^{t+2}^{^{l−1}}) [symbol] xₗ^{t}. (The kernels also act along the entire channel dimension, again, without modifying the channel size.) This dilated structure allows the model to exponentially grow its receptive field with the number of layers, at the cost of just linear parameter growth, enabling efficient processing of both short- and long-term dependencies.

The loss function

$$L := {L}_{c l a s s} + λ {L}_{s mooth} \qquad ( 1 )$$

combines a cross entropy loss with a smoothing loss via a scalar weight λ, chosen empirically. The standard cross entropy loss is defined by

$${L}_{c l a s s} := \frac{1}{T} {\sum }_{t} - log ( {y}_{{c}_{t}}^{t} ) \qquad ( 2 )$$

where y_{c}^{t} is the predicted probability at time t for class c, and cₜ the ground truth class for time t. The smoothing loss is used to reduce rapid, unwarranted jumps in the segmentation assignments, and is defined as a truncated mean squared error between subsequent class log probabilities,

$${L}_{s m o o t h} := \frac{1}{T C} {\sum }_{t , c} {( {⌈ log {y}_{c}^{t} - log {y}_{c}^{t - 1} ⌉}^{κ} )}^{2} \qquad ( 3 )$$

with [symbol] · [symbol] ^{κ} denoting truncation at a threshold κ.

Described herein are the implementation details and experimental results for the non-nutritive sucking (NNS) action recognition and action segmentation models. For NNS action recognition, a range of convolutional and sequential neural backbones were tested, as well as the input modality (RGB vs optical flow), and also specifically gauge performance in challenging settings. For NNS action segmentation, fixed and learned methods were compared for amalgamating the local analysis from the action recognition model into a global segmentation output, and also experiment with other backbones for local feature extraction, such as two-stream and 3D convolutional networks.

For the spatiotemporal core of the NNS action recognition, four configurations of 2D convolutional networks were experimented with, a 1-layer CNN (featuring 8 kernels of 5×5 size), ResNet18, ResNet50, and ResNet101 [12] (with the last layer modified to a learnable 1 ×128 fully connected layer during fine-tuning); and three configurations of sequential networks, an LSTM, a bi-directional LSTM, and a transformer model [31] (each configured with 256 hidden units and 3 recurrent layers). The models were trained for 50 epochs under a learning rate of 0.0001 using PyTorch 1.8.1 with CUDA 10.2, and the best model was chosen based on a held out validation set. Fine-tuning the ResNet18 model, which is trained on the Common Objects in Context (COCO) dataset [17], to develop the CNN-based action recognition model takes approximately 50 minutes. This process is conducted over 50 epochs on an NVIDIA 2080 GPU, utilizing 960 video clips from a clinical dataset. Following this, training the LSTM model for action segmentation takes about 75 minutes.

This method was trained and tested with NNS clinical in-crib data from six infant subjects under a subject-wise leave-one-out cross-validation paradigm. Action recognition accuracies under are reported on the top left of Table 3. Multiple thresholds are used to binarize the confidence scores while predicting to fully evaluate the pipeline. The results in Table 3 are from a confidence threshold of 0.8, and results under other thresholds are shown in Table 4.

TABLE 3
Classification accuracy of the NNS action recognition model, under various convolutional and temporal configurations and two image modalities.
The NNS clinical in-crib data was tested under subject-wise leave-one-out cross-validation, and on the NNS in-the-wild data directly, both
with balanced classes. The strongest results are in bold. The results reported in the current table are under 0.8 confidence threshold.

| | | Convolutional | | | | | | | | |
|---|---|---|---|---|---|---|---|---|---|---|
| | | | Optical flow | | | | RGB | | | |
| | | | 1-lr. CNN | ResNet18 | ResNer50 | ResNet101 | 1-lr. CNN | ResNet18 | ResNet50 | ResNet101 |
| Dataset | Sequential | # Tr. Params. | 333K | 154K | 614K | 614K | 333K | 154K | 614K | 614K |
| Clinical | Transformer | 393K | 79.2 | 92.5 | 94.0 | 78.1 | 50.3 | 50.3 | 50.5 | 50.0 |
| | LSTM | 418K | 85.8 | 95.8 | 82.3 | 85.2 | 51.2 | 50.2 | 50.0 | 50.0 |
| | Bi-LSTM | 535K | 78.6 | 93.4 | 90.6 | 85.8 | 52.3 | 49.8 | 50.0 | 50.0 |
| In-the-wild | Transformer | 393K | 81.5 | 81.2 | 84.0 | 94.6 | 56.8 | 45.9 | 45.9 | 45.9 |
| | LSTM | 418K | 86.3 | 78.4 | 86.0 | 78.7 | 52.0 | 45.9 | 50.2 | 50.2 |
| | Bi-LSTM | 535K | 78.1 | 87.1 | 86.5 | 86.3 | 54.4 | 51.7 | 50.2 | 49.8 |

TABLE 4
Classification accuracy of the NNS action recognition model, under various convolutional and temporal configurations
and two image modalities. The NNS clinical in-crib data was tested under subject-wise leave-one-out cross-validation,
and on the NNS in-the-wild data directly, both with balanced classes. The strongest results are in bold.

| | | | Optical flow | | | | RGB | | | |
|---|---|---|---|---|---|---|---|---|---|---|
| Threshold | Dataset | Sequential | 1-lr. CNN | ResNet18 | ResNet50 | ResNet101 | 1-lr. CNN | ResNet18 | ResNet50 | ResNet101 |
| 0.5 | Clinical | Transformer | 90.9 | 89.4 | 88.5 | 89.2 | 63.5 | 53.5 | 56.4 | 47.3 |
| | | LSTM | 90.7 | 94.9 | 87.9 | 85.2 | 52.9 | 52.1 | 57.5 | 46.8 |
| | | Bi-LSTM | 86.5 | 94.5 | 90.6 | 91.4 | 56.2 | 46.3 | 53.5 | 50.4 |
| | In-the-wild | Transformer | 83.6 | 79.5 | 81.4 | 92.3 | 54.0 | 53.3 | 48.9 | 59.4 |
| | | LSTMI | 84.5 | 80.8 | 84.6 | 82.7 | 50.5 | 55.0 | 50.2 | 50.2 |
| | | Bi-LSTM | 87.2 | 85.2 | 87.5 | 87.2 | 54.4 | 51.7 | 50.2 | 49.8 |
| 0.6 | Clinical | Transformer | 85.2 | 93.9 | 90.9 | 93.4 | 56.9 | 51.6 | 50.5 | 49.6 |
| | | LSTM | 86.3 | 94.4 | 87.9 | 85.9 | 57.3 | 51.8 | 50.0 | 50.0 |
| | | Bi-LSTM | 84.6 | 93.9 | 90.6 | 93.9 | 54.3 | 54.0 | 50.4 | 50.9 |
| | In-the-wild | Transformer | 76.5 | 78.6 | 82.8 | 95.5 | 57.5 | 53.4 | 45.3 | 45.9 |
| | | LSTM | 82.9 | 76.6 | 83.4 | 84.2 | 49.8 | 49.4 | 45.9 | 45.9 |
| | | Bi-LSTM | 76.8 | 85.2 | 85.4 | 90.4 | 57.7 | 45.9 | 45.9 | 45.9 |
| 0.7 | Clinical | Transformer | 82.8 | 93.4 | 92.6 | 86.8 | 53.0 | 51.5 | 50.6 | 50.0 |
| | | LSTMI | 87.0 | 94.9 | 81.0 | 85.2 | 53.8 | 50.6 | 50.0 | 50.0 |
| | | Bi-LSTM | 79.5 | 94.0 | 90.6 | 93.3 | 53.8 | 52.2 | 50.0 | 50.0 |
| | In-the-wild | Transformer | 80.0 | 81.4 | 87.5 | 94.6 | 56.2 | 45.9 | 45.9 | 45.9 |
| | | LSTM | 83.5 | 77.2 | 83.4 | 84.2 | 49.2 | 48.5 | 45.9 | 45.9 |
| | | Bi-LSTM | 76.8 | 87.1 | 86.6 | 86.9 | 48.3 | 45.9 | 45.9 | 45.9 |
| 0.8 | Clinical | Transformer | 79.2 | 92.5 | 94.0 | 78.1 | 50.3 | 50.3 | 50.5 | 50.0 |
| | | LSTM | 85.8 | 95.8 | 82.3 | 85.2 | 51.6 | 50.2 | 50.0 | 50.0 |
| | | Bi-LSTM | 78.6 | 93.4 | 90.6 | 85.8 | 52.3 | 49.8 | 50.0 | 50.0 |
| | In-the-wild | Transformer | 81.5 | 81.2 | 84.0 | 94.6 | 56.8 | 45.9 | 45.9 | 45.9 |
| | | LSTM | 86.3 | 78.4 | 86.0 | 78.7 | 52.0 | 45.9 | 45.9 | 45.9 |
| | | Bi-ASTM | 78.1 | 87.1 | 86.5 | 86.3 | 33.8 | 45.9 | 45.9 | 45.9 |
| 0.9 | Clinical | Transformer | 67.9 | 89.0 | 94.7 | 50.0 | 50.0 | 50.0 | 50.0 | 50.0 |
| | | ISTM | 57.8 | 92.2 | 75.1 | 50.0 | 50.0 | 50.0 | 50.0 | 50.0 |
| | | Bi-LSTM | 75.5 | 90.1 | 90.9 | 67.1 | 50.0 | 50.0 | 50.0 | 50.0 |
| | In-the-wild | Transformer | 80.3 | 83.1 | 56.4 | 88.6 | 58.5 | 45.9 | 45.9 | 45.9 |
| | | LSTM | 72.9 | 82.0 | 89.8 | 82.5 | 45.9 | 45.9 | 45.9 | 45.9 |
| | | Bi-LSTM | 80.0 | 70.8 | 77.2 | 73.0 | 45.9 | 45.9 | 45.9 | 45.9 |

The following elaborates on the choices for the convolutional and sequential networks, and their effect on the results:

Convolutional To explore the influence of the depth of CNN networks for spatial convolution, four CNN structures were utilized: a one-layer learnable convolution network to represent shallow CNN structure; the pre-trained ResNet18, ResNet50, and ResNet101 models for the middle to deep CNN structure. As the results are shown in Table 3, all models with different CNNs were successfully learned and reached over 78.7% accuracy on the NNS clinical in-crib dataset, which demonstrates the feasibility of the proposed CNN-LSTM model with optical flow input. The ResNet18-LSTM configuration performed best, achieving 95.8% average accuracy over six infants using optical flow input. The strong performance (≥78.1%) across all configurations indicates the viability of the overall method.

Sequential Different structures of sequential dynamic event classifiers were explored, including long short-term memory (LSTM), bidirectional LSTM, and transformer. The bi-directional has the same layer settings as the LSTM model, but the forward and backward outputs of the last node are concatenated before inputting into the fully connected layer. The transformer model is formed with 8 heads attention models and the feedforward network with 64 nodes. Bi-directional LSTM is the most robust one since it reaches the highest average accuracy over all CNN models both on the clinical in-crib dataset and on the in-the-wild dataset.

A model was also evaluated trained on all six infants from the NNS clinical in-crib dataset on the independent NNS in-the-wild dataset. Results on the bottom left of Table 3 again show strong cross-configuration performance (≥78.1%), with ResNet101-Transformer reaching 92.3%, demonstrating strong generalizability of the method. As expected, models trained on the NNS clinical in-crib dataset tested worse on the independent NNS in-the-wild dataset. Interestingly, models with the smaller ResNet18 network suffered steep drop-offs in performance when tested on the in-the-wild data, while models based on the complex ResNet101 fared better under the domain shift. Beyond this, it is hard to identify clear trends between configurations or capacities and performance.

The performance of the model is explored under the difficult conditions present in the challenging subset of the NNS clinical in-crib dataset, which includes videos with infants in moving cribs, with faces partially occluded, or under low light conditions. The top half of Table 5 shows performance of the action recognition model when tested on normal data, challenging data, and a mix of both, under the same subject-wise leave-one-out cross-validation configuration as before. The performance on the challenging test data is particularly weak. For more context, precision and recall metrics are included, as well as results under varying classifier confidence thresholds. These show that the model is indiscriminately sensitive, even at higher thresholds.

Next, the experiment included the challenging data in the training, again under the same subject-wise leave-one-out cross-validation configuration. The results are presented in the bottom half of Table 5. The performance is notably stronger on the challenging data, with higher thresholds yielding reasonably high precision as desired for some use cases, but overall performance is still below acceptability for most scientific purposes. Nonetheless, these tests suggest that more training with more challenging data may help overcome issues arising from difficult conditions, and there is also room for specialized techniques to handle background movements, obstructions, and poor lighting.

TABLE 5
Classification performance of the best LSTM-ResNet18 model and tested on different
mixes of the NNS clinical in-crib normal and challenging subsets under different
classification thresholds. The upper half is the evaluation using the model trained
on normal data only, and the lower half is the evaluation using the model trained
on normal and challenging data mixture. The results are the averaged classification
accuracy, precision, and recall evaluated on the six subjects in the in-crib dataset.
The strongest results are in bold for both training sets up.

| | Testing | | | | | | | | | |
|---|---|---|---|---|---|---|---|---|---|---|
| | | Normal only | | | Challenge only | | | Normal + challenge | | |
| Training | Thres. | Acc. | Prec. | Rec. | Acc. | Prec. | Rec. | Acc. | Prec. | Rec. |
| Normal Only | 0.5 | 94.9 | 91.1 | 95.3 | 52.9 | 51.6 | 99.2 | 84.9 | 78.6 | 96.0 |
| | 0.6 | 94.4 | 92.7 | 93.6 | 52.9 | 51.6 | 99.2 | 84.6 | 79.3 | 94.7 |
| | 0.7 | 94.9 | 94.2 | 91.9 | 52.9 | 51.6 | 98.3 | 85.0 | 80.1 | 93.2 |
| | 0.8 | 95.8 | 94.8 | 93.4 | 54.6 | 52.4 | 97.5 | 85.0 | 80.7 | 91.0 |
| | 0.9 | 92.2 | 97.5 | 87.7 | 55.0 | 53.0 | 87.5 | 82.8 | 82.8 | 82.8 |
| Normal + Challenge | 0.5 | 90.6 | 87.2 | 96.9 | 58.8 | 55.7 | 95.8 | 84.5 | 78.3 | 96.7 |
| | 0.6 | 91.7 | 89.0 | 96.3 | 60.4 | 56.9 | 93.3 | 85.4 | 80.1 | 95.7 |
| | 0.7 | 91.4 | 89.8 | 94.4 | 60.0 | 59.0 | 83.3 | 85.1 | 81.7 | 92.2 |
| | 0.8 | 92.2 | 93.2 | 91.9 | 62.5 | 64.8 | 73.3 | 86.3 | 86.1 | 88.2 |
| | 0.9 | 83.6 | 97.0 | 83.8 | 60.0 | 73.3 | 49.0 | 78.9 | 92.7 | 76.8 |

Both the fixed aggregation methods and the deep learning model for NNS action segmentation are evaluated on the 60 second mixed-action videos in the NNS clinical in-crib dataset and the NNS in-the-wild dataset. All methods use the standard evaluation metrics of average precision APₜ and average recall ARₜ based on hits and misses defined by an intersection-over-union (IoU) with threshold t, across common thresholds t∈{0.1, 0.3, 0.5}. Averages are taken with subjects given equal weight, and results are tabulated in Table 6 for the aggregation-based method and Table 7 for the learning-based model.

This starts with the best NNS action recognition model (ResNet18-LSTM) as the local backbone, and test three aggregation-based methods for segmentation based on those local results. The test bed consists of 60 second mixed activity clips, and the same leave-one-out cross-validation paradigm is followed as was for action recognition. In addition to the default classifier threshold of 0.5 used by the action recognition model, a 0.8 threshold was tested to coax higher precision.

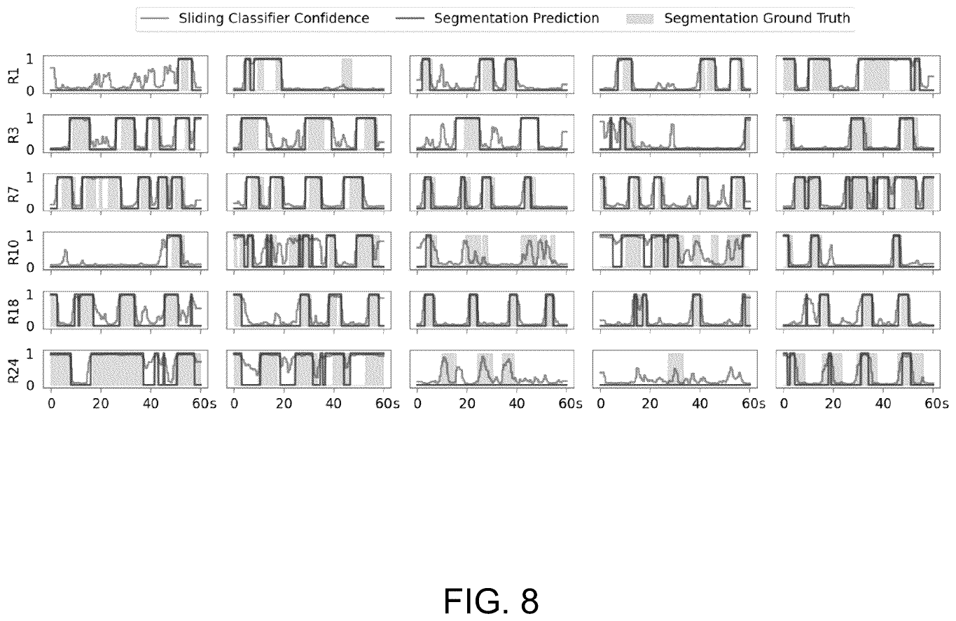

The metrics in Table 6 reveal strong performance from all methods and both confidence thresholds on both test sets. Generally, as expected, setting a higher confidence threshold or employing the more tempered tiled or smoothed aggregation methods favors precision, while lowering the confidence threshold or employing the more responsive sliding aggregation method favors recall. The results are excellent at the IoU threshold of 0.1 but degrade as the threshold is raised, suggesting that while these methods can readily perceive NNS behavior, they are still limited by the underlying ground truth annotator accuracy. The consistency of the performance of the model across both cross-validation testing in the clinical in-crib dataset and the independent testing on the NNS in-the-wild dataset suggests strong generalizability. FIG. 8 visualizes predictions (and underlying confidence scores) of the sliding model configuration with a confidence threshold of 0.8, highlighting the excellent precision characteristics and illustrating the overall challenges of the detection problem.

TABLE 6
Average precision APₜ and average recall ARₜ performance for various IoU thresholds
t of the NNS segmentation model. Three local classification aggregation methods
and two different classifier confidence thresholds were tested. Precision-recall
pairs with the highest precision in each threshold configuration are in bold.

| | | Classifier confidence threshold = 0.8 | | | | | | Classifier confidence threshold = 0.5 | | | | | |
|---|---|---|---|---|---|---|---|---|---|---|---|---|---|
| Dataset | Method | AP_{0.1} | AR_{0.1} | AP_{0.3} | AR_{0.3} | AP_{0.5} | AR_{0.5} | AP_{0.1} | AR_{0.1} | AP_{0.3} | AR_{0.3} | AP_{0.5} | AR_{0.5} |
| Clinical | Tiled | 93.5 | 92.9 | 75.7 | 76.9 | 39.8 | 40.4 | 90.3 | 91.5 | 77.8 | 76.6 | 51.0 | 50.8 |
| | Sliding | 76.5 | 90.1 | 63.5 | 76.4 | 36.1 | 43.4 | 78.3 | 92.7 | 70.3 | 82.5 | 45.4 | 53.1 |
| | Smoothed | 90.2 | 79.9 | 75.6 | 65.9 | 33.5 | 30.8 | 86.9 | 91.0 | 74.0 | 72.9 | 42.6 | 44.8 |
| In-the- | Tiled | 96.0 | 90.4 | 77.7 | 74.8 | 67.6 | 63.4 | 90.8 | 84.2 | 80.5 | 74.4 | 67.9 | 63.5 |
| wild | Sliding | 84.9 | 87.4 | 66.0 | 72.4 | 61.9 | 66.1 | 79.0 | 85.1 | 67.2 | 72.7 | 62.8 | 66.5 |
| | Smoothed | 94.3 | 80.3 | 73.7 | 65.9 | 62.0 | 55.0 | 90.0 | 78.7 | 77.0 | 67.5 | 72.2 | 62.6 |

The same leave-one-out cross-validation pipeline is used to train and test for the learning-based model. However, rather than using final class predictions (NNS or non-NNS) from the NNS action recognition model, the final pre-classification feature vectors are used. Specifically, working at the 10 Hz framerate, each 60 second video has 600 frames, and sliding 26 frames (2.5 second) windows across at a stride of 1 frame results in T=575 unique time points. For each window, x₀^{t} is the 128-dimensional pre-classification feature vector obtained by applying the ResNet18-LSTM model to that window. A dilated convolutional structure is used with L=10 layers, and loss weight λ=0.15. The resulting performance metrics are tabulated in the bottom row of Table 7. The table also compares this pipeline with similar ones obtained by swapping the NNS action recognition model with other state-of-the-art action recognition models, trained on the same data, and again, with features taken from the pre-classification layer and fed into the action segmentation model.

TABLE 7
The action segmentation performance of the deep-learning-based
model. Other state-of-the-art action recognition models including
Inflated 3D ConvNet (I3D) [4], X3D [10], and 3D ResNet
[16] are converted into feature extractors and follow
the same pipeline to input into the deep-learning-based model.

| Dataset | Method | AP_{0.1} | AR_{0.1} | AP_{0.3} | AR_{0.3} | AP_{0.5} | AR_{0.5} |
|---|---|---|---|---|---|---|---|
| Clinical | I3D | 50.7 | 63.4 | 37.6 | 44.1 | 17.8 | 20.8 |
| | X3D | 45.4 | 54.8 | 26.4 | 30.9 | 9.6 | 12.5 |
| | 3D ResNet | 35.8 | 13.5 | 26.4 | 10.3 | 19.4 | 8.6 |
| | Ours | 88.4 | 86.5 | 80.5 | 76.7 | 64.4 | 63.5 |
| In-the- wild | I3D | 75.4 | 81.0 | 59.2 | 62.7 | 32.2 | 35.7 |
| | X3D | 68.8 | 44.2 | 34.3 | 26.1 | 18.6 | 18.6 |
| | 3D ResNet | 62.5 | 51.2 | 30.3 | 28.0 | 18.4 | 15.3 |
| | Ours | 91.0 | 88.5 | 78.3 | 74.1 | 58.6 | 54.7 |

The results show that the learning-based model still can reach strong performance on both the clinical in-crib dataset and the in-the-wild dataset, attaining high precision as desired. Furthermore, compared to the aggregation-based methods (Table 6), the learned model exhibits more robust performance across multiple IoU thresholds while training and testing on the clinical in-crib dataset compared to the aggregation-based methods: the average precision ranges from 64.4% to 88.4% for the learning-based method, compared to 39.8% to 93.5% for the aggregation-based method. The learned model also achieves better precision and recall at higher IoU thresholds, suggesting that it provides more precise segments overall.

Various configurations have been tested for the NNS action recognition and NNS action segmentation pipelines, including different choices of architecture for deep network components. As described below, these pipelines are instead tested against direct competitors: state-of-the-art action recognition and action segmentation models.

Three widely recognized deep-learning-based action recognition methods are involved: I3D [4], X3D [10], and 3D ResNet [16]. Unlike the other two only using RGB input, the I3D method introduced another parallel network stream that takes optical flow as input and combines the RGB stream and optical flow stream together to make action prediction. Therefore, besides the original I3D two-stream structure, fine-tuning on the RGB stream and optical flow stream is also performed independently to explore the effect of the input. The results are presented in Table 8. As the results show, the proposed CNN-LSTM-based model reached the best performance on accuracy and precision for both the clinical in-crib dataset and in-the-wild dataset. Also, the I3D fine-tuned results align with the performance of the proposed method, which is optical flow input only has much better performance than the RGB input. The comparison shows the advantage of the model described herein for dealing with subtle actions such as the NNS compared to the state-of-the-art models which are trained on general actions.

TABLE 8
Comparison with the state-of-the-art action recognition methods. I3D [4]
represents the original two-stream (RGB + optical flow) structure.
I3D RGB and I3D OP represent the cases in which only the RGB stream or optical
flow stream of the I3D pre-trained model is used. X3D [10], and 3D ResNet
[16] models are fine-tuned on the clinical in-crib dataset and tested
on the in-the-wild dataset. The strongest results are in bold for both datasets.

| Data | Evaluation | I3D | I3D RGB | I3D OP | X3D | 3D ResNet | Ours |
|---|---|---|---|---|---|---|---|
| Clinical | Accuracy | 77.4 | 67.4 | 80.5 | 74.5 | 72.9 | 95.8 |
| | Precision | 81.0 | 73.8 | 83.1 | 85.0 | 81.9 | 94.3 |
| | Recall | 60.6 | 67.2 | 77.9 | 66.6 | 65.0 | 92.7 |
| In-the-Wild | Accuracy | 65.0 | 65.9 | 69.7 | 77.5 | 73.7 | 78.4 |
| | Precision | 60.6 | 73.0 | 65.1 | 80.6 | 82.5 | 83.8 |
| | Recall | 100.0 | 82.6 | 100.0 | 84.0 | 80.2 | 81.5 |

For the action segmentation models, the deep-learning-based action segmentation model is compared to the Global2Local [11] method and ASFormer [34]. All the models are trained and tested following the same pipeline as the proposed end-to-end-based method with the same feature input extracted from the pre-trained ResNet18-LSTM model. The comparisons are shown in Table 9, as the results show, the end-to-end-based method reached better average precision than the other methods under all IoU thresholds. Also, all models reached relatively close performance under all IoU thresholds with less than 15% difference trained with the features extracted by the proposed pre-trained ResNet18-LSTM model, demonstrating the action recognition model feature extractor is general enough.

Performance of all models with raw RGB input replacing optical flow frames can be found on the right side of Table 3. The results are weak and close to random guessing, demonstrating the critical role played by optical flow in detecting the subtle NNS signal. This can also be seen clearly in the sample optical flow frames visualized in FIGS. 7A and 7B.

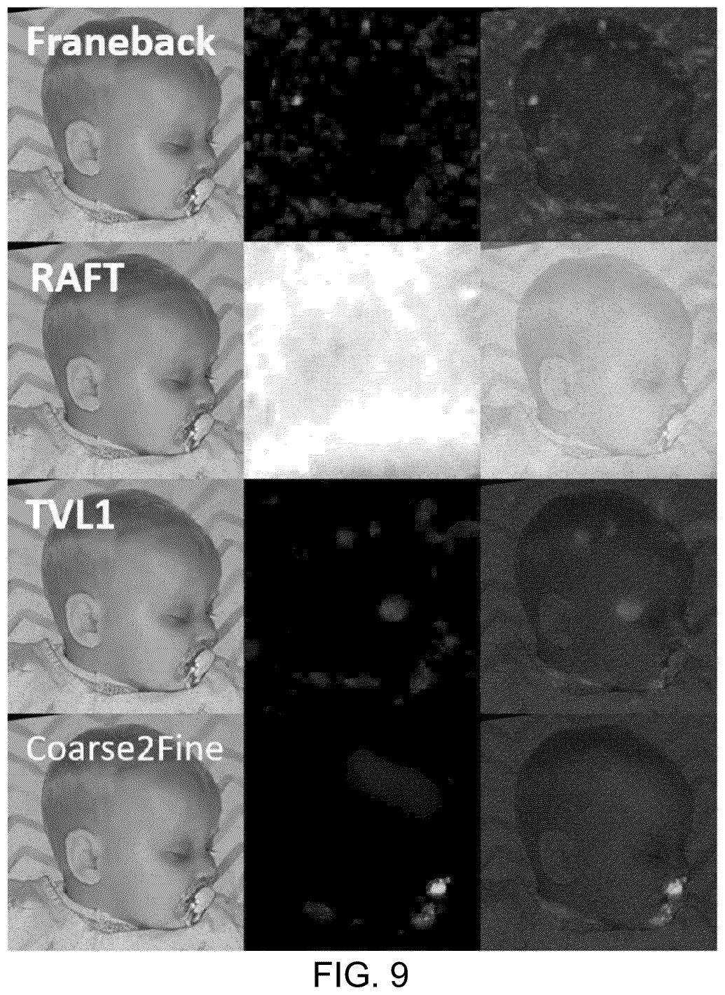

Multiple well-accepted optical flow methods were evaluated including Farneback [9], TV-L1 [26], and Recurrent All-Pairs Field Transforms (RAFT) [30]. The visualizations are shown in FIG. 9. As the comparison shows, the accepted Croase2Fine method has the least background noise and strongest task-related area response.

The fine-tuned I3D, X3D, and 3D ResNet models were converted into feature extractors by removing the last layer and then substituted them for the feature extractor based on the NNS action recognition model, within the learning-based NNS action segmentation model. A comparison of performance results can be found in Table 7. The specifically designed ResNet18-LSTM-based feature extractor performed better than all the other methods for all IoU thresholds in both datasets.

This work has focused on action detection and action segmentation of non-nutritive sucking. In some embodiments, the techniques and methods described herein may be applied to more granular features of the sucking signal, including suck frequency and amplitude. This is technically feasible by using a computer vision approach and then estimating respiration rate and waveforms from similar infant video footage [20]. The NNS action segmentation can support these developments both at the research and deployment phases, by identifying the segments of NNS activity within hours-long overnight sleep videos for fine-grained annotation or processing, respectively.

While the clinical dataset is captured exclusively by the infrared mode of the camera and is restricted to a perspective above the crib, both choices reflecting a nighttime application domain, this same approach may be applied during waking hours of the day with full-color video and a wider range of camera lighting and angles.

This study addresses the complex coordination of sucking, swallowing, and breathing in newborns and preterm infants—a challenge for nearly 2.8 million infants annually in the U.S. Traditional subjective methods like the finger test for non-nutritive sucking (NNS) can be imprecise and invasive. As described herein, the video-based algorithms for NNS action recognition and action segmentation may be used to accelerate neurodevelopmental research and the development of clinical and commercial monitoring tools. Also described herein are extensive video datasets for NNS action recognition and action segmentation, drawing videos from both overnight sleep sessions and everyday settings.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

[1] Benjasuwantep, B., Chaithirayanon, S., Eiamudomkan, M., 2013. Feeding problems in healthy Young children: Prevalence, related factors and feeding practices. Pediatr. Rep. 5 (2), e10. dx.doi.org/10.4081/pr.2013.e10, URL: ww.mdpi.com/2036-7503/5/2/e10.
[2] Bolme, D. S., Beveridge, J. R., Draper, B. A., Lui, Y. M., 2010. Visual object tracking using adaptive correlation filters. In: 2010 IEEE Computer Society Conference on Computer Vision and Pattern Recognition. pp. 2544-2550. dx.doi.org/10.1109/CVPR.2010.5539960.
[3] Carlin, R. F., Moon, R. Y., 2017. Risk factors, protective factors, and current recommendations to reduce sudden infant death syndrome: a review. JAMA Pediatr. 171 (2), 175-180.
[4] Carreira, J., Zisserman, A., 2017. Quo vadis, action recognition? a new model and the kinetics dataset. In: Proceedings of the IEEE Conference on Computer Vision and Pattern Recognition. pp. 6299-6308.
[5] Deng, J., Dong, W., Socher, R., Li, L. J., Li, K., Fei-Fei, L., 2009. Imagenet: A largescale hierarchical image database. In: 2009 IEEE Conference on Computer Vision and Pattern Recognition. Ieee, pp. 248-255.
[6] Deng, J., Guo, J., Ververas, E., Kotsia, I., Zafeiriou, S., 2020. Retinaface: Single-shot multi-level face localisation in the wild. In: Proceedings of the IEEE/CVF Conference on Computer Vision and Pattern Recognition. pp. 5203-5212.
[7] Dutta, A., Zisserman, A., 2019. The VIA annotation software for images, audio and video. In: Proceedings of the 27th ACM International Conference on Multimedia. MM '19, ACM, New York, NY, USA, dx.doi.org/10.1145/3343031.3350535.
[8] Farha, Y.A., Gall, J., 2019. Ms-tcn: Multi-stage temporal convolutional network for action segmentation. In: Proceedings of the IEEE/CVF Conference on Computer Vision and Pattern Recognition. pp. 3575-3584.
[9] Farnebäck, G., 2003. Two-frame motion estimation based on polynomial expansion. In: Scandinavian Conference on Image Analysis. Springer, pp. 363-370.
[10] Feichtenhofer, C., 2020. X3d: Expanding architectures for efficient video recognition. In: Proceedings of the IEEE/CVF Conference on Computer Vision and Pattern Recognition. pp. 203-213.
[11] Gao, S. H., Han, Q., Li, Z. Y., Peng, P., Wang, L., Cheng, M. M., 2021. Global2local: Efficient structure search for video action segmentation. In: Proceedings of the IEEE/CVF Conference on Computer Vision and Pattern Recognition. pp. 16805-16814.
[12] He, K., Zhang, X., Ren, S., Sun, J., 2016. Deep residual learning for image recognition. In: Proceedings of the IEEE Conference on Computer Vision and Pattern Recognition. pp. 770-778.
[13] Huang, X., Martens, A., Zimmerman, E., Ostadabbas, S., 2019. Infant contact-less non-nutritive sucking pattern quantification via facial gesture analysis. In: CVPR Workshops.
[14] Huber, P., Hu, G., Tena, R., Mortazavian, P., Koppen, P., Christmas, W. J., Ratsch, M., Kittler, J., 2016. A multiresolution 3d morphable face model and fitting framework. In: Proceedings of the 11th International Joint Conference on Computer Vision, Imaging and Computer Graphics Theory and Applications. University of Surrey.
[15] Idrees, H., Zamir, A. R., Jiang, Y. G., Gorban, A., Laptev, I., Sukthankar, R., Shah, M., 2017. The THUMOS challenge on action recognition for videos “in the wild”. Comput. Vis. Image Underst. 155, 1-23. dx.doi.org/10.1016/j.cviu.2016.10.018, arXiv: 1604.06182 [cs].
[16] Kataoka, H., Wakamiya, T., Hara, K., Satoh, Y., 2020. Would mega-scale datasets further enhance spatiotemporal 3D cnns? arXiv preprint arXiv:2004.04968.
[17] Lin, T. Y., Maire, M., Belongie, S., Hays, J., Perona, P., Ramanan, D., Dollár, P., Zitnick, C. L., 2014. Microsoft coco: Common objects in context. In: Computer Vision-ECCV 2014: 13th European Conference, Zurich, Switzerland, Sep. 6-12, 2014, Proceedings, Part V 13. Springer, pp. 740-755.
[18] Liu, C., et al., 2009. Beyond Pixels: Exploring New Representations and Applications for Motion Analysis (Ph.D. thesis). Massachusetts Institute of Technology.
[19] Lucas, B. D., Kanade, T., et al., 1981. An Iterative Image Registration Technique with an Application to Stereo Vision, vol. 81, Vancouver.
[20] Manne, S. K. R., Zhu, S., Ostadabbas, S., Wan, M., 2023. Automatic infant respiration estimation from video: A deep flow-based algorithm and a novel public benchmark. In: International Workshop on Preterm, Perinatal and Paediatric Image Analysis. Springer, pp. 111-120.
[21] Maron, O., Lozano-Pérez, T., 1997. A framework for multiple-instance learning. Adv. Neural Inf. Process. Syst. 10.
[22] Martens, A., Hines, M., Zimmerman, E., 2020. Changes in non-nutritive suck between 3 and 12 months. Early Hum. Dev. 149, 105141. dx.doi.org/10.1016/j.earlhumdev.2020.105141, URL: linkinghub.elsevier.com/retrieve/pii/S0378378220303807.
[23] McHugh, M. L., 2012. Interrater reliability: the kappa statistic. Biochem. Med. 22 (3), 276-282.
[24] Medoff-Cooper, B., Ray, W., 1995. Neonatal sucking behaviors. Imag. J. Nurs. Scholarsh. 27 (3), 195-200. dx.doi.org/10.1111/j.1547-5069.1995.tb00858.x, URL: onlinelibrary.wiley.com/doi/10.1111/j.1547-5069.1995.tb00858.x.
[25] Oord, A. v. d., Dieleman, S., Zen, H., Simonyan, K., Vinyals, O., Graves, A., Kalchbrenner, N., Senior, A., Kavukcuoglu, K., 2016. WaveNet: A generative model for raw audio. arXiv: 1609.03499 [cs].
[26] Pock, T., Urschler, M., Zach, C., Beichel, R., Bischof, H., 2007. A duality based algorithm for TV-1 1-optical-flow image registration. In: International Conference on Medical Image Computing and Computer-Assisted Intervention. Springer, pp. 511-518.
[27] Poore, M., Zimmerman, E., Barlow, S., Wang, J., Gu, F., 2008. Patterned orocutaneous therapy improves sucking and oral feeding in preterm infants. Acta Paediatr. 97 (7), 920-927.
[28] Psaila, K., Foster, J.P., Pulbrook, N., Jeffery, H.E., 2017. Infant pacifiers for reduction in risk of sudden infant death syndrome. Cochrane Database Syst. Rev. 2017 (4), dx.doi.org/10.1002/14651858.CD011147.pub2, URL: doi.wiley.com/10.1002/14651858.CD011147.pub2.
[29] Shi, J., et al., 1994. Good features to track. In: 1994 Proceedings of IEEE Conference on Computer Vision and Pattern Recognition. IEEE, pp. 593-600.
[30] Teed, Z., Deng, J., 2020. Raft: Recurrent all-pairs field transforms for optical flow. In: European Conference on Computer Vision. Springer, pp. 402-419.
[31] Vaswani, A., Shazeer, N., Parmar, N., Uszkoreit, J., Jones, L., Gomez, A. N., Kaiser, ä., Polosukhin, I., 2017. Attention is all you need. Adv. Neural Inf. Process. Syst. 30.
[32] Wan, M., Zhu, S., Luan, L., Gulati, P., Huang, X., Schwartz-Mette, R., Hayes, M., Zimmerman, E., Ostadabbas, S., 2022. InfAnFace: Bridging the infant-adult domain gap in facial landmark estimation in the wild. In: 26th International Conference on Pattern Recognition. ICPR.
[33] Warren, J. J., Levy, S. M., Nowak, A. J., Tang, S., 2000. Non-nutritive sucking behaviors in preschool children: a longitudinal study. Pediatr. Dent. 22 (3), 187-191.
[34] Yi, F., Wen, H., Jiang, T., 2021. Asformer: Transformer for action segmentation. arXiv preprint arXiv: 2110.08568.
[35] Yue-Hei Ng, J., Hausknecht, M., Vijayanarasimhan, S., Vinyals, O., Monga, R., Toderici, G., 2015. Beyond short snippets: Deep networks for video classification. In: Proceedings of the IEEE Conference on Computer Vision and Pattern Recognition. pp. 4694-4702.
[36] Zavala Abed, B., Oneto, S., Abreu, A. R., Chediak, A.D., 2020. How might non nutritional sucking protect from sudden infant death syndrome. Med. Hypotheses 143, 109868. dx.doi.org/10.1016/j.mehy.2020.109868, URL: linkinghub.elsevier.com/retrieve/pii/S0306987720307386.
[37] Zhu, S., Wan, M., Hatamimajoumerd, E., Kamath, C. V., Jain, K., Zlota, S., Grace, E., Rowan, C., Goodwin, M., Schwartz-Mette, R., Zimmerman, E., Hayes, M., Ostadabbas, S., 2023. A video-based end-to-end pipeline for non-nutritive sucking action recognition and segmentation in Young infants. In: International Conference on Medical Image Computing and Computer-Assisted Intervention. MICCAI.
[38] Zimmerman, E., Carpenito, T., Martens, A., 2020. Changes in infant non-nutritive sucking throughout a suck sample at 3-months of age. PLOS One 15 (7), e0235741. dx.doi.org/10.1371/journal.pone.0235741, URL: dx.plos.org/10.1371/journal.pone.0235741.
[39] Zimmerman, E., Foran, M., 2017. Patterned auditory stimulation and suck dynamics in full-term infants. Acta Paediatr. 106 (5), 727-732. dx.doi.org/10.1111/apa.13751, URL: onlinelibrary.wiley.com/doi/10.1111/apa.13751.

What is claimed is:

1. A computer implemented method for detecting non-nutritive sucking (NNS) in video, comprising:
receiving video data of an infant exhibiting an NNS action;
determining a sequence of video segments from the video data, wherein the video segments are a fixed length and the sequence of video segments determined from the video data are based on a sliding window of the fixed length and a stride that is less than the fixed length wherein each video segment includes an overlap with sequential neighbor video segments;
performing action recognition for each video segment of the sequence of video segments;
receiving a sequence of feature vectors corresponding to the sequence of video segments and based on the action recognition, wherein the feature vectors represent features extracted from a pre-classification feature layer of an action recognition network;
determining, using a dilated convolution network with the sequence of feature vectors as input, an NNS action prediction for each frame of the video data; and
determining a start time and an end time for an NNS action in the video data based on the NNS action prediction for each frame of the video data.

2. The computer implemented method of claim 1, wherein performing the action recognition further comprises:
receiving a first video segment, the first video segment comprising a plurality of frames;
determining a plurality of face bounding boxes capturing a facial region by performing face detection, wherein a face bounding box of the plurality of face bounding boxes corresponds to each frame of the plurality of frames;
determining a plurality of cropped frames by cropping each frame of the plurality of frames based on the face bounding box corresponding to each frame of the plurality of frames, wherein each cropped frame of the plurality of cropped frames has a corresponding frame in the plurality of frames;
determining optical flow direction vectors for pixels of each cropped frame of the plurality of cropped frames based on calculating dense optical flow between consecutive frames of the plurality of cropped frames;
generating a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and
determining a segment feature vector, from the pre-classification feature layer of the action recognition network, for the first video segment based on the plurality of optical flow frames.

3. The computer implemented method of claim 2, further comprising:
determining an NNS classification, using the action recognition network, for the first video segment based on the plurality of optical flow frames, wherein determining the NNS classification using the action recognition network further comprises:
determining a plurality of spatial features corresponding to the plurality of optical flow frames using a conventional 2D convolutional network;
determining a plurality of frame NNS classifications corresponding to the plurality of spatial features using a temporal 1D convolution network; and
determining the NNS classification for the first video segment based on the plurality of frame NNS classifications.

4. The computer implemented method of claim 2, wherein determining the face bounding box for each frame of the plurality of frames further comprises:
determining a first bounding box, based on the face detection, for at least one frame of the plurality of frames; and
propagating the first bounding box to adjacent frames of the at least one frame.

5. The computer implemented method of claim 4, wherein determining the face bounding box for each frame of the plurality of frames further comprises:
determining first saliency corners for the first bounding box of the at least one frame; and
modifying a second bounding box for a subsequent frame of the at least one frame based on tracking the first saliency corners to second saliency corners of the subsequent frame.

6. The computer implemented method of claim 2, wherein determining the face bounding box for each frame of the plurality of frames further comprises:
determining a trajectory for the plurality of face bounding boxes by applying a moving average filter; and
modifying the plurality of face bounding boxes to stabilize the facial region by applying the trajectory to each face bounding box of the plurality of face bounding boxes.

7. The computer implemented method of claim 2, wherein generating the plurality of optical flow frames further comprises:
determining the color value for the pixels of each cropped frame of the plurality of cropped frames by combining the optical flow direction vectors for the pixels of each cropped frame of the plurality of cropped frames with a magnitude for the pixels of each cropped frame of the plurality of cropped frames, wherein the color value is in Hue, Saturation, and Value (HSV) color space.

8. A computer implemented method for generating a non-nutritive sucking (NNS) training dataset, comprising:
receiving a plurality of video recordings, wherein the plurality of video recordings are recordings of infants exhibiting NNS actions and wherein each video recording includes NNS labeling that identifies a segment of the video recording that includes NNS; and
generating the NNS training dataset for training a dilated convolution network as a labeled sequence of feature vectors for each video recording of the plurality of video recordings, wherein generating the labeled sequence of feature vectors for a particular video recording of the plurality of video recordings further comprises:
determining a sequence of video segments from the particular video recording, wherein the video segments are a fixed length and the sequence of video segments determined from the particular video recording are based on a sliding window of the fixed length and a stride that is less than the fixed length wherein each video segment includes an overlap with sequential neighbor video segments;
performing action recognition for each video segment of the sequence of video segments;
receiving a sequence of feature vectors corresponding to the sequence of video segments and based on the action recognition, wherein the feature vectors represent features extracted from a pre-classification feature layer of an action recognition network; and
labeling the sequence of feature vectors corresponding to the NNS labeling of the particular video recording.

9. A computer implemented method for generating a non-nutritive sucking (NNS) training dataset, comprising:
receiving a plurality of video segments capturing infants exhibiting an NNS action or not exhibiting an NNS action, wherein each video segment of the plurality of video segments comprises a plurality of frames and wherein each video segment includes an NNS labelling classification of NNS or non-NNS;
generating the NNS training dataset for training an action recognition network as a labeled optical flow frame set for each video segment of the plurality of video segments, wherein generating the labeled optical flow frame set for a particular video segment of the plurality of video segments further comprises:
determining a plurality of face bounding boxes capturing a facial region by performing face detection, wherein a face bounding box of the plurality of face bounding boxes corresponds to each frame of the plurality of frames for the particular video segment;
determining a plurality of cropped frames by cropping each frame of the plurality of frames based on the face bounding box corresponding to each frame of the plurality of frames, wherein each cropped frame of the plurality of cropped frames has a corresponding frame in the plurality of frames;
determining optical flow direction vectors for pixels of each cropped frame of the plurality of cropped frames based on calculating dense optical flow between consecutive frames of the plurality of cropped frames;
generating a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and
labeling the plurality of optical flow frames corresponding to the NNS labeling classification of the particular video segment.

10. The computer implemented method of claim 9, wherein determining the face bounding box for each frame of the plurality of frames further comprises:
determining a first bounding box, based on the face detection, for at least one frame of the plurality of frames; and
propagating the first bounding box to adjacent frames of the at least one frame.

11. The computer implemented method of claim 10, wherein determining the face bounding box for each frame of the plurality of frames further comprises:
determining first saliency corners for the first bounding box of the at least one frame; and
modifying a second bounding box for a subsequent frame of the at least one frame based on tracking the first saliency corners to second saliency corners of the subsequent frame.

12. The computer implemented method of claim 9, wherein determining the face bounding box for each frame of the plurality of frames further comprises:
determining a trajectory for the plurality of face bounding boxes by applying a moving average filter; and
modifying the plurality of face bounding boxes to stabilize the facial region by applying the trajectory to each face bounding box of the plurality of face bounding boxes.

13. The computer implemented method of claim 9, prior to determining the optical flow direction vectors for pixels of each cropped frame of the plurality of cropped frames, modifying the plurality of cropped frames by performing random transformations to the plurality of cropped frames, wherein the random transformations include at least one of rotation, scaling, or mirroring.

14. The computer implemented method of claim 9, wherein generating a plurality of optical flow frames further comprises:
determining the color value for the pixels of each cropped frame of the plurality of cropped frames by combining the optical flow direction vectors for the pixels of each cropped frame of the plurality of cropped frames with a magnitude for the pixels of each cropped frame of the plurality of cropped frames, wherein the color value is in Hue, Saturation, and Value (HSV) color space.

15. A system for detecting non-nutritive sucking (NNS) in video, comprising:
at least one processor; and
at least one memory including instructions that, when executed by the at least one processor, cause the system to:
receive video data of an infant exhibiting an NNS action;
determine a sequence of video segments from the video data, wherein the video segments are a fixed length and the sequence of video segments determined from the video data are based on a sliding window of the fixed length and a stride that is less than the fixed length wherein each video segment includes an overlap with sequential neighbor video segments;
perform action recognition for each video segment of the sequence of video segments;
receive a sequence of feature vectors corresponding to the sequence of video segments and based on the action recognition, wherein the feature vectors represent features extracted from a pre-classification feature layer of an action recognition network;
determine, using a dilated convolution network with the sequence of feature vectors as input, an NNS action prediction for each frame of the video data; and
determine a start time and an end time for a NNS action in the video data based on the NNS action prediction for each frame of the video data.

16. The system of claim 15, wherein performing the action recognition, the at least one memory further comprises instructions that, when executed by the at least one processor, further cause the system to:
receive a first video segment, the first video segment comprising a plurality of frames;
determine a plurality of face bounding boxes capturing a facial region by performing face detection, wherein a face bounding box of the plurality of face bounding boxes corresponds to each frame of the plurality of frames;
determine a plurality of cropped frames by cropping each frame of the plurality of frames based on the face bounding box corresponding to each frame of the plurality of frames, wherein each cropped frame of the plurality of cropped frames has a corresponding frame in the plurality of frames;
determine optical flow direction vectors for pixels of each cropped frame of the plurality of cropped frames based on calculating dense optical flow between consecutive frames of the plurality of cropped frames;
generate a plurality of optical flow frames based on converting the optical flow direction vectors for pixels of each cropped frame of the plurality of cropped frames into a color value, wherein each optical flow frame of the plurality of optical flow frames corresponds to a frame of the plurality of frames; and
determine a segment feature vector, from the pre-classification feature layer of the action recognition network, for the first video segment based on the plurality of optical flow frames.

17. The system of claim 16, wherein the at least one memory further comprises instructions that, when executed by the at least one processor, further cause the system to:
determine an NNS classification, using the action recognition network, for the first video segment based on the plurality of optical flow frames, wherein determining the NNS classification using the action recognition network further comprises:
determine a plurality of spatial features corresponding to the plurality of optical flow frames using a conventional 2D convolutional network;
determine a plurality of frame NNS classifications corresponding to the plurality of spatial features using a temporal 1D convolution network; and
determine the NNS classification for the first video segment based on the plurality of frame NNS classifications.

18. The system of claim 16, wherein determining the face bounding box for each frame of the plurality of frames, the at least one memory further comprises instructions that, when executed by the at least one processor, further cause the system to:
determine a first bounding box, based on the face detection, for at least one frame of the plurality of frames; and
propagate the first bounding box to adjacent frames of the at least one frame.

19. The system of claim 16, wherein determining the face bounding box for each frame of the plurality of frames, the at least one memory further comprises instructions that, when executed by the at least one processor, further cause the system to:
determine a trajectory for the plurality of face bounding boxes by applying a moving average filter; and
modify the plurality of face bounding boxes to stabilize the facial region by applying the trajectory to each face bounding box of the plurality of face bounding boxes.

20. The system of claim 16, wherein generating a plurality of optical flow frames, the at least one memory further comprises instructions that, when executed by the at least one processor, further cause the system to:
determine the color value for the pixels of each cropped frame of the plurality of cropped frames by combining the optical flow direction vectors for the pixels of each cropped frame of the plurality of cropped frames with a magnitude for the pixels of each cropped frame of the plurality of cropped frames, wherein the color value is in Hue, Saturation, and Value (HSV) color space.
